(19) United States
(12) Patent Application Publication
(10) Pub. No.: US 2016/0152859 A1
(43) Pub. Date: Jun. 2, 2016

(54) ADHESION-STRENGTHENING ADDITIVE AND COATING COMPOSITION CONTAINING SAME

(71) Applicant: BYK-CHEMIE GMBH, Wesel (DE)

(72) Inventors: Bernd GÖBELT, Wesel (DE); René NAGELSDIEK, Hamminkeln (DE); Jürgen OMEIS, Dorsten-Lembeck (DE); Jörg BÖMER, Wesel (DE); Carina SCHEPERS, Wesel (DE)

(73) Assignee: BYK-CHEMIE, GmbH, Wesel (DE)

(21) Appl. No.: 14/900,668

(22) PCT Filed: Jun. 24, 2014
(86) PCT No.: PCT/EP2014/063232

§ 371 Date: Dec. 22, 2015

(30) Foreign Application Priority Data
Jun. 24, 2013 (EP) 13173425.3

(51) Int. Cl. C09D 133/12; C09J 133/12; C09J 133/06; C09D 133/06

(52) U.S. Cl. CPC C09D 133/12; C09D 133/066; C09J 133/12; C09J 133/066

(57) ABSTRACT

The present invention relates to a use of at least one homopolymer or copolymer which is obtainable by polymerizing ethylenically unsaturated monomers and which is composed of at least one structural unit (W0) or of at least two structural units (W1) and (W2) differing from one another, and also optionally of at least one other structural unit (W3) differing from (W0), (W1) and (W2), where each structural unit (W0) contains not only at least one functional group comprising at least one phosphorus atom, but also at least one functional group reactive towards an isocyanate group, each structural unit (W1) has at least one functional group having at least one phosphorus atom, each structural unit (W2) has at least one functional group reactive towards an isocyanate group, where none of the structural units (W2) comprises phosphorus atoms, and the homopolymer or copolymer contains, relative to the total quantity of the at least one structural unit (W0) within the main polymer chain of the homopolymer or copolymer, from 1 to 100 mol % of the structural units (W0) or, relative to the total quantity of the at least two structural units (W1) and (W2) within the main polymer chain of the homopolymer or copolymer, from 1 to 80 mol % of the structural units (W1) and from 1 to 80 mol % of the structural units (W2), as adhesion-strengthening additive, a coating composition containing this type of homopolymer or copolymer as component (A) and at least one binder as component (B), and also a use of this coating composition as clearcoat, on production lines, for rehabilitation, or for maintenance.

The present invention relates to use of at least one homopolymer or copolymer obtainable by polymerization of ethylenically unsaturated monomers, which is composed of at least one structural unit (W0) or of at last two structural units (W1) and (W2) different from one another and optionally at least one further structural unit (W3) different from (W0), (W1) and (W2), wherein each structural unit (W0) both contains at least one functional group which contains at least one phosphorus atom, and also contains at least one functional group reactive towards an isocyanate group, each structural unit (W1) contains at least one functional group which contains at least one phosphorus atom, each structural unit (W2) contains at least one functional group reactive towards an isocyanate group, wherein none of the structural units (W2) contains phosphorus atoms, and the homopolymer or copolymer, based on the total quantity of the at least one structural unit (W0) within the polymer main chain of the homopolymer or copolymer, contains 1 to 100 mol. % of the structural units (W0) or, based on the total quantity of the at least two structural units (W1) and (W2) within the polymer main chain of the homopolymer or copolymer, contains 1 to 80 mol. % of the structural units (W1) and 1 to 80 mol. % of the structural units (W2), as an adhesion-strengthening additive, a coating composition containing such a homopolymer or copolymer as component (A) and at least one binder as component (B), and use of this coating composition as clear lacquer, production line lacquer, repair lacquer or maintenance lacquer.

From the prior art, a large number of different coating compositions for different application fields are known.

The coatings thus applied onto appropriate substrates can serve various purposes, such as for example purely decorative purposes, but also as protection of the substrate from harmful influences. In many cases it is necessary that not only one coating is applied onto a substrate or onto a substrate surface, but instead two or more such coatings which usually differ in their composition and in their desired property profile are applied successively. Typical application examples of such multilayer coatings are multilayer lacquers such as for example automobile lacquers, coil lacquers, industrial lacquers, corrosion protection lacquers or print colors. A further case in which several lacquer layers are applied on top of one another is represented by repair lacquers or maintenance lacquers, in which an already lacquered surface is newly lacquered either selectively or as a whole, for example because the aged lacquer layer is weathered or has been damaged.

In many cases however, it can be observed that with such multilayer lacquers adhesion problems between the individual lacquer layers occur and for example as a result of environmental influences at least partial detachment of “upper” lacquer layers from lacquer layers lying below them can occur. This is not only undesired for visual aesthetic reasons, but also massively impairs the functionality of the lacquer, in particular when the lacquer serves as a protective barrier, such as for example as a mechanical protective barrier, as protection against UV radiation and/or as corrosion protection for the lacquered substrate. In order to be able to guarantee the desired functionality of the lacquer, it is therefore essential not only that the first lacquer layer applied directly onto the substrate adheres sufficiently to this, but also the individual further applied layers adhere sufficiently to this first lacquer layer and also to one another, so that no at least partial undesired delamination occurs between the individual lacquer layers and/or the substrate.

In order to prevent the occurrence of such adhesion problems, the use of additives which have an adhesion-strengthening action is known from the prior art. Such adhesion promoters are for example known from M. N. Sathyanarayana et al., Progress in organic Coatings 1995, 26, 275-313. Here, the adhesion promoters can be used either as a component of the coating to be applied onto an optionally already coated substrate or onto an optionally already coated substrate surface or else first, even before the application of the actual coating, as a component of a pretreatment layer or adhesion promoter layer onto an optionally coated substrate or onto an optionally already coated substrate surface.

Multilayer lacquers for substrates are often used in fields in which the multilayer lacquers to be used are permanently being optimized and/or altered, for example with regard to the use of raw materials from renewable sources, the replacement of certain ingredients because of chemicals legislation and ecological requirements or simply for cost reasons. Because of the constantly altered composition of the particular lacquer layer due to this, particularly in the case of finishes such as repair finishes or maintenance finishes, but also with production line finishes an altered adhesion behavior often results, for example between the lacquer layer to be lacquered over and the finish lacquer layer then applied thereon, as a result of which problems as regards the interlayer adhesion between these two layers such as for example at least partial undesired delamination can occur.

From WO 96/06894 A1, aqueous coatable compositions usable in the can-coating process are known, which inter alia contain a phosphorus-containing polymer as binder. From DE 38 07 588 A1, phosphorus-containing (meth)acrylic copolymer binders are known. References to an adhesion-strengthening action of these (co)polymers and to coating compositions which contain such a (co)polymer in additive quantities in each case are to be found neither in WO 96/06894 A1 nor in DE 38 07 588 A1.

From DE 44 26 323 A1, polyacrylate resin solutions are known which contain as an additive a phosphite such as triisodecyl phosphite. References to (co)polymers which have phosphorus-containing functional groups, and corresponding coating compositions containing these are not to be found in DE 44 26 323 A1. EP 0 218 248 A2 discloses a polymerizable mixture of oligomeric or prepolymeric compounds which contain several polymerizable unsaturated groups and several acid groups such as for example phosphoric acid residues. Corresponding polymers obtained therefrom, which in addition contain functional groups reactive towards isocyanate groups, are not disclosed in EP 0 218 248 A2.

There is therefore a need for adhesion-strengthening additives, by means whereof the above-mentioned disadvantages, particularly as regards the interlayer adhesion between a lacquer layer of a substrate to be overpainted and the overpainted lacquer layer applied onto it in the case of overpainting such as for example repair painting or maintenance painting can be at least partly avoided.

One purpose of the present invention is therefore to provide an adhesion-strengthening additive which has advantages compared to normally used adhesion-strengthening additives. In particular, it is a purpose of the present invention to provide such an adhesion-strengthening additive, which mediates sufficiently good adhesion between an optionally coated substrate and a coating applied thereon such as a lacquer layer. In particular it is a purpose of the present invention to provide such an adhesion-strengthening additive, which provides sufficiently good adhesion between a substrate already coated with at least one lacquer layer such as for example a substrate coated with a base lacquer and a lacquer applied thereon such as for example a clear lacquer layer applied thereon, i.e. an adhesion-strengthening additive, which mediates sufficiently good interlayer adhesion between at least these two layers of a multilayer lacquer finish such as for example a base lacquer layer and a clear lacquer layer.

This problem is solved by use of at least one homopolymer or copolymer obtainable by polymerization, preferably copolymerization, of ethylenically unsaturated monomers, preferably copolymers, as an adhesion-strengthening additive,

which is composed of at least one structural unit (W0) and optionally at least one further structural unit (W3) different from (W0),
wherein
each structural unit (W0) both contains at least one functional group which contains at least one phosphorus atom, and also contains at least one functional group reactive towards an isocyanate group,
and the homopolymer or copolymer, based on the total quantity of the at least one structural unit (W0) and optionally (W3) within the polymer main chain of the homopolymer or copolymer, contains the following proportions in mol. %:
   1 to 100 mol. % of the structural units (W0) and
   0 to 99 mol. % of the structural units (W3),

or which is composed of at least two structural units (W1) and (W2) different from one another and optionally at least one further structural unit (W3) different from (W1) and (W2),
wherein
each structural unit (W1) contains at least one functional group which contains at least one phosphorus atom, and optionally at least one part of the structural units (W1) additionally contains at least one functional group reactive towards an isocyanate group, and
each structural unit (W2) contains at least one functional group reactive towards an isocyanate group, wherein none of the structural units (W2) contains phosphorus atoms,
and the homopolymer or copolymer, based on the total quantity of the at least two structural units (W1) and (W2) and optionally (W3) within the polymer main chain of the homopolymer or copolymer, contains the following proportions in mol. %:
   1 to 80 mol. % of the structural units (W1),
   1 to 80 mol. % of the structural units (W2) and
   0 to 98 mol. % of the structural units (W3).

A first subject of the present invention is therefore use of at least one such homopolymer or copolymer, preferably copolymer, as an adhesion-strengthening additive.

Preferably here additionally none of the optionally present structural units (W3) contains phosphorus atoms. Preferably here additionally none of the optionally present structural units (W3) contains functional groups reactive towards an isocyanate group.

The use of the at least one homopolymer or copolymer as an adhesion-strengthening additive here preferably takes place in combination with at least one binder (B), in particular at least one polyurethane and/or at least one polyurea as binder (B), in particular as a component of a coating composition comprising at least the homopolymer or copolymer used according to the invention as an adhesion-strengthening additive (A), which additionally optionally contains at least one binder (B).

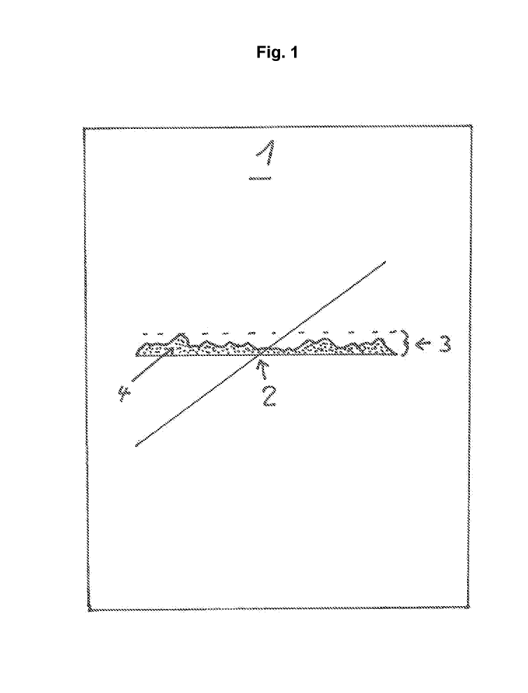

The adhesive properties of the homopolymer or copolymer used according to the invention can be tested and assessed with the determination method described below (see section: “Determination methods” and FIG. 1).

It has surprisingly been found that the homopolymer or copolymer used according to the invention is characterized by an adhesion-strengthening action, in particular by an adhesion-strengthening action between two layers of a substrate coated with at least two layers. For example, the homopolymer or copolymer used according to the invention is characterized by an adhesion-strengthening action between at least one first lacquer layer applied on a substrate, such as for example a base lacquer layer, and a further lacquer layer applied thereon, such as for example a clear lacquer layer, and can therefore be used as an adhesion promoter, in particular in order to achieve sufficiently good interlayer adhesion between these layers. It has further also surprisingly been found that the homopolymer or copolymer used according to the invention additionally is also characterized by an adhesion-strengthening action between an uncoated substrate and an at least one lacquer layer applied thereon and therefore in this respect can also be used as an adhesion promoter.

In particular it was surprisingly found that the homopolymer or copolymer used according to the invention can also be used both as an adhesion-strengthening additive as a component of a coating composition such as for example a clear lacquer composition, whereby for example sufficiently good adhesion of a corresponding clear lacquer layer on a base lacquer layer can be achieved, or alternatively can be provided as a component of an adhesion promoter layer, which contains at least the homopolymer or copolymer used according to the invention as an adhesion promoter, wherein this layer is applied as interlayer between two layers such as a base lacquer layer and a clear lacquer layer and ensures sufficiently good adhesion between these two layers or is applied onto an uncoated substrate as a component of a primer layer and in turn a further layer is applied onto this, wherein the primer layer ensures sufficiently good adhesion between substrate and the further layer.

It has further surprisingly been found that the homopolymer or copolymer used according to the invention as an adhesion-strengthening additive can be incorporated in a simple manner into coating compositions such as clear lacquer compositions. Further it has surprisingly been found that the homopolymer or copolymer used according to the invention as an adhesion-strengthening additive does not adversely influence the further processing of such coating compositions and additionally does not adversely influence the desired properties of the particular coating compositions such as clear lacquer compositions through its presence as a component therein.

A further subject of the present invention is use of a homopolymer or copolymer obtainable by polymerization, preferably copolymerization, of ethylenically unsaturated monomers as an adhesion-strengthening additive, which is obtainable by radical polymerization of
(a) at least one ethylenically unsaturated monomer capable of forming the structural unit (W1), which contains at least one functional group which contains at least one phosphorus atom, at least one ethylenically unsaturated monomer capable of forming the structural unit (W2), which contains at least one functional group reactive towards an isocyanate group, and optionally at least one ethylenically unsaturated monomer capable of forming the structural unit (W3),
or by radical polymerization of
(b1) at least two ethylenically unsaturated monomers different from each other capable of forming the structural unit (W2), which each mutually independently contain at least one functional group reactive towards an isocyanate group, and optionally at least one ethylenically unsaturated monomer capable of forming the structural unit (W3),
   or
   of at least one ethylenically unsaturated monomer capable of forming the structural unit (W2), which contains at least one functional group reactive towards an isocyanate group, and at least one ethylenically unsaturated monomer capable of forming the structural unit (W3),
and
(b2) partial conversion of the functional groups reactive towards isocyanate groups contained in the structural units (W2) of the homopolymer or copolymer obtainable according to step (b1) into functional groups which contain at least one phosphorus atom, for the formation of structural units (W1) or (W0) within the homopolymer or copolymer,
or by radical copolymerization of
(c) at least one ethylenically unsaturated monomer capable of forming the structural unit (W0), which both contains at least one functional group which contains at least one phosphorus atom, and also contains at least one functional group reactive towards an isocyanate group, and optionally at least one ethylenically unsaturated monomer capable of forming the structural unit (W3).

Homopolymer or Copolymer

The homopolymer or copolymer used according to the invention is composed of at least one structural unit (W0) and optionally at least one further structural unit (W3) different from (W0), wherein each structural unit (W0) both contains at least one functional group which contains at least one phosphorus atom, and also contains at least one functional group reactive towards an isocyanate group, or is composed of at least two structural units (W1) and (W2) different from one another and optionally at least one further structural unit (W3) different from (W1) and (W2), wherein each structural unit (W1) contains at least one functional group which contains at least one phosphorus atom, and each structural unit (W2) contains at least one functional group reactive towards an isocyanate group. Preferably the structural unit (W3) contains neither a functional group which contains at least one phosphorus atom, nor at least one functional group reactive towards an isocyanate group.

The terms “homopolymer” and “copolymer” are known to those skilled in the art. A homopolymer used according to the invention is for example present when this is exclusively composed of structural units (W0), wherein each structural unit (W0) both contains at least one functional group which contains at least one phosphorus atom, and also contains at least one functional group reactive towards an isocyanate group. Such a homopolymer is obtainable by polymerization of suitable ethylenically unsaturated monomers. A copolymer used according to the invention is for example present when this is composed both of structural units (W0) and (W3) or for example both of structural units (W1), (W2) and (W3).

Preferably the homopolymer or copolymer used according to the invention is a copolymer.

In a preferred embodiment, the homopolymer or copolymer used according to the invention is composed of at least one structural unit (W0) and optionally at least one further structural unit (W3) different from (W0). In another preferred embodiment, the homopolymer or copolymer used according to the invention is composed of at least two structural units (W1) and (W2) different from one another and optionally at least one further structural unit (W3) different from (W1) and (W2).

Each structural unit (W0) here contains at least one functional group which contains at least one phosphorus atom. The structural units (W0) contained in the homopolymer or copolymer used according to the invention here can, apart from the fact that each of the structural units (W0) contains at least one functional group which contains at least one phosphorus atom, differ in their chemical structure, depending on whether a single suitable monomer or a mixture of suitable monomers is used for the incorporation of the structural units (W0) into the homopolymer or copolymer used according to the invention. The structural units (W0) contained in the homopolymer or copolymer used according to the invention can additionally each differ in the nature of the at least one functional group which contains at least one phosphorus atom. For example, one structural unit (W0) can contain a phosphonic acid group and another structural unit (W0) a phosphate ester group. In a preferred embodiment, the structural units (W0) contained in the homopolymer or copolymer used according to the invention do not differ from one another. In another preferred embodiment, the structural units (W0) contained in the homopolymer or copolymer used according to the invention differ from one another. Preferably here, the homopolymer or copolymer used according to the invention contain at least two or three different structural units (W0).

Each structural unit (W0), as well as the at least one functional group which contains at least one phosphorus atom, additionally contains at least one functional group reactive towards an isocyanate group, in particular at least one optionally protected OH group. An example of a suitable monomer which can be used for the production of the structural unit (W0) within the homopolymer or copolymer are for example [(3-(meth)acryloyloxy-2-hydroxypropyl)]phosphate and/or [(2-(meth)acryloyloxy-3-hydroxypropyl)]phosphate. Alternatively, a monomer such as glycidyl (meth)acrylate can also be used, the epoxide group whereof after incorporation into the homopolymer or copolymer can be converted with ring opening, for example by reaction with phosphoric acid, to a group which contains both an OH group as a functional group reactive towards an isocyanate group, and also a phosphate monoester group as a functional group which contains at least one phosphorus atom. Another example of a group contained in the structural unit (W0), which both contains at least one functional group which contains at least one phosphorus atom, and also contains at least one functional group reactive towards an isocyanate group, is for example a dialkyl phosphate ester group, one alkyl group whereof is substituted with an OH group.

Each structural unit (W1) here contains at least one functional group which contains at least one phosphorus atom. The structural units (W1) contained in the homopolymer or copolymer used according to the invention can here, apart from the fact that each of the structural units (W1) contains at least one functional group which contains at least one phosphorus atom, differ in their chemical structure, depending on whether a single suitable monomer or a mixture of suitable monomers is used for the incorporation of the structural units (W1) in the homopolymer or copolymer used according to the invention. The structural units (W1) contained in the homopolymer or copolymer used according to the invention can additionally each differ in the nature of the at least one functional group which contains at least one phosphorus atom. For example, one structural unit (W1) can contain a phosphonic acid group and another structural unit (W1) a phosphate ester group. In a preferred embodiment, the structural units (W1) contained in the homopolymer or copolymer used according to the invention do not differ from another. In another preferred embodiment, the structural units (W1) contained in the homopolymer or copolymer used according to the invention differ from one another. Preferably here, the homopolymer or copolymer used according to the invention contains at least two or three different structural units (W1).

Each structural unit (W1), as well as the at least one functional group which contains at least one phosphorus atom, can optionally additionally contain at least one further functional group such as for example at least one functional group reactive towards an isocyanate group, in particular at least one optionally protected OH group. An example of such a group is for example a dialkyl phosphate ester group, one alkyl group whereof is substituted with an OH group. Another example of such a group is for example a dihydroxy-substituted alkyl group, one hydroxy function whereof is converted by means of a phosphorylating reagent into a functional group which contains at least one phosphorus atom. A corresponding ethylenically unsaturated monomer suitable for the production of the homopolymer or copolymer used according to the invention is for example a dihydroxyalkyl (meth)acrylate such as 2,3-dihydroxypropyl (meth)acrylate, one OH function whereof, has been/is phosphorylated for example in the 2-position by means of a phosphorylating agent after production of the homopolymer or copolymer or, still in the form of the monomer, before production of the homopolymer or copolymer, whereas the remaining OH function, for example in the 3-position, is a functional group reactive towards an isocyanate group.

Thus structural units within the homopolymer or copolymer used according to the invention, which both contain at least one functional group which contains at least one phosphorus atom, and also at least one functional group reactive towards an isocyanate group, are also to be subsumed under the structural unit (W0) or (W1).

In a preferred embodiment, however, the structural unit (W1), as well as the at least one functional group which contains at least one phosphorus atom, contains no functional group reactive towards an isocyanate group.

Preferably, the structural unit (W0) or the structural unit (W1) within the homopolymer or copolymer used according to the invention is in each case the only one of all structural units (W1), (W2) and optionally (W3) or (W0) and optionally (W3) contained in the homopolymer or copolymer which is phosphorus-containing, i.e. which contains at least one functional group which contains at least one phosphorus atom.

Each structural unit (W2) contains at least one functional group reactive towards an isocyanate group. The structural units (W2) contained in the homopolymer or copolymer used according to the invention can here, apart from the fact that each of the structural units (W2) contains at least one functional group reactive towards an isocyanate group, differ in their chemical structure, depending on whether a single suitable monomer or a mixture of suitable monomers for the incorporation of the structural units (W2) is used in the homopolymer or copolymer used according to the invention. The structural units (W2) contained in the homopolymer or copolymer used according to the invention can additionally each differ in the nature of the at least one functional group reactive towards an isocyanate group. For example, one structural unit (W2) can contain a hydroxyl group and another structural unit (W2) a carboxyl group. In a preferred embodiment, the structural units (W2) contained in the homopolymer or copolymer used according to the invention do not differ from one another. In another preferred embodiment, the structural units (W2) contained in the homopolymer or copolymer used according to the invention differ from one another. Preferably, in this case the homopolymer or copolymer used according to the invention contains at least two or three different structural units (W2).

Preferably, each structural unit (W2), apart from the at least one functional group reactive towards an isocyanate group, contains no further functional group. The structural unit (W2) contains no phosphorus-containing group and thus no functional group which contains at least one phosphorus atom.

Preferably, the structural unit (W0) or (W2) within the homopolymer or copolymer used according to the invention in each case is the only one of all structural units (W1), (W2) and optionally (W3) or (W0) and optionally (W3) contained in the homopolymer or copolymer which contains at least one functional group reactive towards an isocyanate group.

Preferably, the homopolymer or copolymer used according to the invention is composed of recurring structural units (W1) and (W2) and optionally (W3) or is composed of recurring structural units (W0) and optionally (W3).

Optionally, the homopolymer or copolymer used according to the invention can comprise at least one further structural unit (W3) different from (W1) and (W2) or from (W0). Preferably, the homopolymer or copolymer used according to the invention comprises at least one such further structural unit (W3). The further structural unit (W3) is different from the structural units (W1) and (W2) or (W0). Preferably, the structural unit (W3) contains neither a functional group which contains at least one phosphorus atom, nor at least one functional group reactive towards an isocyanate group. Thus the structural unit (W3) is preferably not phosphorus-containing. The structural units (W3) optionally contained in the homopolymer or copolymer used according to the invention can also differ from one another in their chemical structure, depending on whether a single suitable monomer or a mixture of suitable monomers is used for the incorporation of the structural units (W3) in the homopolymer or copolymer used according to the invention. In a preferred embodiment, the structural units (W3) contained in the homopolymer or copolymer used according to the invention do not differ from one another. In another preferred embodiment, the structural units (W3) contained in the homopolymer or copolymer used according to the invention differ from one another. Preferably, in this case the homopolymer or copolymer used according to the invention contains at least two or three different structural units (W3).

Preferably, the homopolymer or copolymer used according to the invention is obtainable by radical polymerization, preferably copolymerization. Here, at least two ethylenically unsaturated monomers different from one another are preferably used. Alternatively, also only one ethylenically unsaturated monomer, for example a monomer which contains at least one functional group reactive towards an isocyanate group, and optionally additionally at least one monomer capable of forming the structural unit (W3), are firstly used and the functional groups reactive towards isocyanate groups contained in the homopolymer then obtainable or, if additionally at least one monomer capable of forming the structural unit (W3) has been used, in the copolymer then obtainable, are further converted, partly by means of polymer-analogous reactions for the incorporation of the structural units (W1) or (W0), for example by phosphorylation.

In a preferred embodiment, the homopolymer or copolymer used according to the invention is a copolymer which is obtainable by copolymerization of preferably at least two ethylenically unsaturated compounds, which are preferably different from one another. Preferably in this case the polymer main chain of the copolymer is built up by this polymerization, i.e. both the at least one functional group of (W1) which contains at least one phosphorus atom, and also the at least one functional group reactive towards an isocyanate group contained in (W2), or the two corresponding functional groups present in (W0), are preferably located in the side chains or side groups and not in the main chain of the copolymer used according to the invention.

The at least two ethylenically unsaturated compounds used for the production of the homopolymer or copolymer used according to the invention preferably each contain at least one terminal ethylenically unsaturated group.

The homopolymer or copolymer used according to the invention can be of linear, comb-shaped, star-shaped or branched structure. Preferably, that used according to the invention has a linear or comb-shaped structure.

Preferably, the homopolymer or copolymer used according to the invention contains in the side groups of its polymer chain at least one functional group which contains at least one phosphorus atom, and additionally at least one functional group reactive towards an isocyanate group.

The distribution of the at least two structural units (W1) and (W2) or the at least one structural unit (W0) and optionally (W3) in the homopolymer or copolymer used according to the invention can be both random and also structured. Preferably, the distribution of the at least two preferably recurring structural units (W1) and (W2) or of the at least one preferably recurring structural unit (W0) and optionally (W3) in the homopolymer or copolymer used according to the invention is random.

Preferably, the homopolymer or copolymer used according to the invention has a linear or comb-shaped structure, in which the distribution of the at least two structural units (W1) and (W2) or of the at least one structural unit (W0) and optionally (W3) is random.

If a structured distribution is present, then the at least two structural units (W1) and (W2) and optionally (W3) in the homopolymer or copolymer used according to the invention are preferably gradient or block distributed. In this case, the homopolymer or copolymer used according to the invention contains segments (S1), in which the proportion of the at least two structural units (W1) and (W2) or the proportion of at least two different structural units (W0) and optionally (W3) differs quantitatively from the proportion of the at least two structural units (W1) and (W2) or of the at least one different structural unit (W0) and optionally (W3) in other segments (S2) of the same homopolymer or copolymer molecule used according to the invention.

Gradient homopolymers or copolymers used according to the invention are preferably homopolymers or copolymers, the polymer main chain whereof is formed by polymerization of preferably at least two ethylenically unsaturated compounds which are different from one another, and in which along the polymer main chain the concentration of at least one of the at least two structural units (W1) or (W2) or of one of at least two different structural units (W0) decreases continuously and the concentration of the remaining one of the at least two structural units (W1) or (W2) or of the remaining further structural unit (W0) increases. The term “gradient copolymer” is known to those skilled in the art. Thus for example gradient copolymers are disclosed in EP 1 416 019 A1, WO 01/44389 A1 and in Macromolecules 2004, 37, page 966 ff., Macromolecular Reaction Engineering 2009, 3, page 148 ff., Polymer 2008, 49, page 1567 ff. and Biomacromolecules 2003, 4, page 1386 ff.

Block type copolymers used according to the invention (block copolymers) are preferably copolymers the polymer main chain whereof is formed by addition of at least two ethylenically unsaturated compounds which are different from one another, each at different times during implementation of a controlled polymerization reaction for the production of the copolymer used according to the invention. Here for example an addition of at least two different ethylenically unsaturated monomers, two different mixtures of ethylenically unsaturated monomers or an addition of one ethylenically unsaturated monomer and a mixture of ethylenically unsaturated monomers can take place. In this, all ethylenically unsaturated monomers or mixtures of ethylenically unsaturated monomers used in the polymerization can be added in portions or metered into the reaction mixture during the implementation of the polymerization, or one ethylenically unsaturated monomer or a mixture of ethylenically unsaturated monomers is introduced at the start of the reaction and the other ethylenically unsaturated monomers or mixtures of ethylenically unsaturated monomers are metered in. With the addition of the further ethylenically unsaturated monomers or of the mixture of ethylenically unsaturated monomers or the addition of ethylenically unsaturated monomers in several portions, the ethylenically unsaturated monomers introduced at the start of the polymerization or those already metered in up to this time can be either already completely reacted or else partly unpolymerized. As a result of such a polymerization, block copolymers used according to the invention contain at least one, but optionally also several abrupt or gradient-like transitions in their at least two structural units (W1) or (W2) or in at least two different structural units (W0) along the polymer main chain, which represents the boundary between the respective individual blocks. Such block copolymer structures which can preferably be used are for example AB diblock copolymers or ABA or ABC triblock copolymers, in which the A, B and C blocks represent a different composition of the structural units (W1), (W2) and optionally (W3). The term “block copolymer” is known to those skilled in the art. Thus for example in U.S. Pat. No. 6,849,679, U.S. Pat. No. 4,656,226, U.S. Pat. No. 4,755,563, U.S. Pat. No. 5,085,698, U.S. Pat. No. 5,160,372, U.S. Pat. No. 5,219,945, U.S. Pat. No. 5,221,334, U.S. Pat. No. 5,272,201, U.S. Pat. No. 5,519,085, U.S. Pat. No. 5,859,113, U.S. Pat. No. 6,306,994, U.S. Pat. No. 6,316,564, U.S. Pat. No. 6,413,306, EP 1416019, EP 1803753, WO 01/44389 and WO 03/046029, block copolymers are disclosed. Block copolymers which are preferably used according to the invention contain blocks with a minimum number of 3 structural units per block. Preferably, the minimum number of structural units per block is 3, particularly preferably 5 and quite especially preferably 8. Particularly preferably, they are block structures of the type A-B, A-B-A, B-A-B, A-B-C and/or A-C-B, wherein the blocks A, B and C differ from one another through their respective composition of structural units in two adjacent blocks by at least 5 wt. %.

The structural units (W1) and (W2) or (W0) and optionally (W3) are preferably recurring. The recurring structural units here are preferably repeating chemical structural units within the homopolymer or copolymer used according to the invention. Preferably, each of the structural units (W1), (W2) or (W0) and optionally (W3) contained in the homopolymer or copolymer used according to the invention is derived from a monomer used for the production of the homopolymer or copolymer.

The homopolymers or copolymers used according to the invention, based on the total quantity of the at least two structural units (W1) and (W2) and optionally (W3) within the polymer main chain of the homopolymer or copolymer, contain the following proportions in mol. %:
1 to 80 mol. % of the structural units (W1)
1 to 80 mol. % of the structural units (W2) and
0 to 98 mol. % of the structural units (W3)

or, based on the total quantity of the at least one structural unit (W0) and optionally (W3) within the polymer main chain of the homopolymer or copolymer, contain the following proportions in mol. %:
1 to 100 mol. % of the structural units (W0) and
0 to 99 mol. % of the structural units (W3).

Here it is clear to those skilled in the art that the total content of the at least two structural units (W1) and (W2) or of the at least one structural unit (W0) and optionally (W3) within the polymer main chain of the homopolymer or copolymer overall makes up 100 mol. %. Here, the polymer main chain of the homopolymer or copolymer used according to the invention is preferably the polymer chain obtainable by radical polymerization such as copolymerization of preferably at least two mutually different ethylenically unsaturated monomers.

Preferably
70 to 100 mol. % of the at least one functional group of each of the structural units (W1) or (W0) containing at least one phosphorus atom of the homopolymer or copolymer are each mutually independently selected from the group consisting of phosphonic acid groups, at least partially esterified phosphonic acid groups, at least partially esterified phosphoric acid groups and respective corresponding salts of these groups,
and/or
70 to 100 mol. % of the at least one functional group reactive towards an isocyanate group of each of the structural units (W2) or (W0) and optionally of the structural units (W1) of the homopolymer or copolymer are each mutually independently selected from the group consisting of optionally protected hydroxyl groups, in particular free hydroxyl groups, thiol groups, epoxide groups, carboxyl groups, optionally protected primary amino groups and optionally protected secondary amino groups, particularly preferably selected from the group consisting of optionally protected hydroxyl groups, in particular free hydroxyl groups, epoxide groups, optionally protected primary amino groups and optionally protected secondary amino groups and quite especially preferably selected from the group consisting of optionally protected hydroxyl groups and optionally protected primary amino groups and optionally protected secondary amino groups, in particular hydroxyl groups.

Preferably the copolymers used according to the invention, based on the total quantity of the at least two structural units (W1) and (W2) and (W3) within the polymer main chain of the copolymer, contain the following proportions in mol. %:
3 to 40 mol. % of the structural units (W1)
3 to 40 mol. % of the structural units (W2) and
20 to 94 mol. % of the structural units (W3)

or, based on the total quantity of the at least one structural unit (W0) and optionally (W3) within the polymer main chain of the copolymer, contain the following proportions in mol. %:
6 to 80 mol. % of the structural units (W0) and
20 to 94 mol. % of the structural units (W3).

In a further preferred embodiment, the copolymers used according to the invention, based on the total quantity of the at least two structural units (W1) and (W2) and (W3) within the polymer main chain of the copolymer, contain the following proportions in mol. %:
4 to 30 mol. % of the structural units (W1)
4 to 30 mol. % of the structural units (W2) and
40 to 92 mol. % of the structural units (W3)

or, based on the total quantity of the at least one structural unit (W0) and optionally (W3) within the polymer main chain of the copolymer, contain the following proportions in mol. %:
8 to 60 mol. % of the structural units (W0) and
40 to 92 mol. % of the structural units (W3).

In a quite especially preferred embodiment, the copolymers used according to the invention, based on the total quantity of the at least two structural units (W1) and (W2) and (W3) within the polymer main chain of the copolymer, contain the following proportions in mol. %:
7 to 20 mol. % of the structural units (W1)
7 to 20 mol. % of the structural units (W2) and
60 to 86 mol. % of the structural units (W3)

or, based on the total quantity of the at least one structural unit (W0) and optionally (W3) within the polymer main chain of the copolymer, contain the following proportions in mol. %:
14 to 40 mol. % of the structural units (W0) and
60 to 86 mol. % of the structural units (W3).

In particular, the copolymers used according to the invention, based on the total quantity of the at least two structural units (W1) and (W2) and (W3) within the polymer main chain of the copolymer, contain the following proportions in mol. %:
10 to 17 mol. % of the structural units (W1)
6 to 12 mol. % of the structural units (W2) and
71 to 84 mol. % of the structural units (W3)

or, based on the total quantity of the at least one structural unit (W0) and optionally (W3) within the polymer main chain of the copolymer, contain the following proportions in mol. %:
16 to 29 mol. % of the structural units (W0) and
71 to 84 mol. % of the structural units (W3).

The homopolymers or copolymers used according to the invention preferably have a number average molecular weight in a range from 600 to 250,000 g/mol, still more preferably from 850 to 250,000 g/mol or from 1,000 to 250,000 g/mol, particularly preferably from 850 to 150,000 g/mol or from 1,000 to 150,000 g/mol, quite especially preferably from 850 to 100,000 g/mol or from 1,000 to 100,000 g/mol, particularly preferably from 850 to 50,000 g/mol or from 1,000 to 50,000 g/mol, still more preferably from 850 to 25,000 g/mol or from 1,000 to 25,000 g/mol, most preferably from 1,250 to 10,000 g/mol or from 1,500 to 10,000 g/mol and in particular most preferably from 1,250 to 6,000 g/mol or from 1,500 to 6,000 g/mol. Here it is known to those skilled in the art that the desired number average molecular weight can be controlled by suitable selection of the reaction conditions in the production of the homopolymers or copolymers used according to the invention, such as for example the initiator concentration of the initiators used in their production, the polymerization temperature, the solvent and/or the selection of a chain transfer agent. Typical chain transfer agents for achieving the desired number average molecular weight are for example mercaptans, secondary alcohols, dimers such as dimers of (meth)acrylates or of a-methylstyrene and/or halogenated hydrocarbons. The determination of the number average molecular weight here is effected by gel permeation chromatography (GPC) against polystyrene standards according to the method described below.

The homopolymer or copolymer used according to the invention is preferably obtainable by radical polymerization of
(a) at least one ethylenically unsaturated monomer capable of forming the structural unit (W1), which contains at least one functional group which contains at least one phosphorus atom, at least one ethylenically unsaturated monomer capable of forming the structural unit (W2), which contains at least one functional group reactive towards an isocyanate group, preferably at least one optionally protected hydroxyl group or at least one optionally protected carboxyl group or at least one optionally protected primary or secondary amino group, and optionally at least one ethylenically unsaturated monomer capable of forming the structural unit (W3),
or by radical polymerization of
(b1) at least two ethylenically unsaturated monomers different from each other capable of forming the structural unit (W2), which each mutually independently contain at least one functional group reactive towards an isocyanate group, preferably each mutually independently contain at least one optionally protected hydroxyl group and/or at least one carboxyl group and/or at least one optionally protected primary or secondary amino group, and optionally at least one ethylenically unsaturated monomer capable of forming the structural unit (W3),
   or
   of at least one ethylenically unsaturated monomer capable of forming the structural unit (W2), which contains at least one functional group reactive towards an isocyanate group, preferably at least one optionally protected hydroxyl group or at least one optionally protected carboxyl group or at least one optionally protected primary or secondary amino group, and at least one ethylenically unsaturated monomer capable of forming the structural unit (W3),
and
(b2) partial conversion, preferably by phosphorylation, of the functional groups reactive towards isocyanate groups, preferably hydroxyl groups, in the structural units (W2) of the homopolymer or copolymer obtainable according to step (b1), into functional groups which contain at least one phosphorus atom, for the formation of structural units (W1) or (W0) within the homopolymer or copolymer,
or by radical polymerization of
(c) at least one ethylenically unsaturated monomer capable of forming the structural unit (W0), which both contains at least one functional group which contains at least one phosphorus atom, and also contains at least one functional group reactive towards an isocyanate group, and optionally at least one ethylenically unsaturated monomer capable of forming the structural unit (W3).

Particularly preferably, the homopolymer or copolymer used according to the invention is obtainable by radical polymerization of
(b1a) at least two ethylenically unsaturated monomers different from each other capable of forming the structural unit (W2), which each contain at least one optionally protected hydroxyl group reactive towards an isocyanate group, and optionally at least one ethylenically unsaturated monomer capable of forming the structural unit (W3), or of
   at least one ethylenically unsaturated monomer capable of forming the structural unit (W2), which contains at least one optionally protected hydroxyl group reactive towards an isocyanate group, and at least one ethylenically unsaturated monomer capable of forming the structural unit (W3),
and
(b2a) partial phosphorylation of the hydroxyl groups contained in the structural units (W2) of the homopolymer or copolymer obtainable according to step (b1a) for the formation of structural units (W1) or (W0) within the homopolymer or copolymer.

The reactive hydroxyl group here can in each case also be present in protected form.

In a preferred embodiment each
structural unit (W1) or (W0) contains as functional group containing at least one phosphorus atom at least one group selected from the group consisting of phosphonic acid groups, at least partially esterified phosphonic acid groups, at least partially esterified phosphoric acid groups, and respective corresponding salts of these groups, and
each structural unit (W2) or (W0) and optionally (W1) contains as at least one functional group reactive towards an isocyanate group at least one group selected from the group consisting of hydroxyl groups, thiol groups, epoxide groups, carboxyl groups primary amino groups and secondary amino groups.

Structural Units (W0) and (W1)

Each structural unit (W1) and each structural unit (W0) within the homopolymer or copolymer used according to the invention contains at least one functional group which contains at least one, preferably exactly one, phosphorus atom.

Preferably, each structural unit (W1) or (W0) contains as functional group containing at least one phosphorus atom at least one group selected from the group consisting of phosphonic acid groups, at least partially esterified phosphonic acid groups, at least partially esterified phosphoric acid groups, and respective corresponding salts of these groups such as for example phosphonates or phosphates. Here the phosphonate ester groups and phosphate ester groups can in each case be completely or only partially esterified groups. For example, a phosphate ester group includes both a phosphate monoester group and also a phosphate diester group and also a phosphate triester group. It is clear to those skilled in the art that a completely esterified phosphonic acid group or a completely esterified phosphoric acid group cannot be present in the form of a salt. Particularly preferably, the phosphonic acid groups and partially esterified phosphonic acid groups and phosphoric acid groups are each present in non-salt form. Suitable alcohols for the partial or complete esterification of the phosphonate ester groups and phosphate ester groups are preferably C₁₋₈ aliphatic alcohols, particularly preferably C₁₋₈ alkyl alcohols such as methanol, ethanol, n-propanol, iso-propanol, n-butanol, iso-butanol, and tert-butanol.

Preferably, 70 to 100 mol. % of the at least one functional group containing at least one phosphorus atom of each of the structural units (W1) or (W0) of the homopolymer or copolymer are each mutually independently selected from the group consisting of phosphonic acid groups, at least partially esterified phosphonic acid groups, at least partially esterified phosphoric acid groups and respective corresponding salts of these groups.

Here, in connection with the aforementioned at least partially esterified phosphoric acid groups it is clear to those skilled in the art that the linking of such a group to the structural unit (W1) preferably takes place via the oxygen atom of a P—O bond within this group. Thus the linking of such a group with the structural unit (W1) preferably always takes place via formation or “expenditure” of an ester bond. The further P—OH groups of the at least partially esterified phosphoric acid group can be esterified with suitable usable alcohols such as C₁₋₈ aliphatic alcohols. If exactly one of the further P—OH groups is esterified with an alcohol, then the at least partially esterified phosphoric acid group is for example a phosphate diester. The same applies for the structural unit (W0).

The structural unit (W0) contains both at least one functional group which contains at least one phosphorus atom, and also at least one functional group reactive towards an isocyanate group. As functional groups which contain at least one phosphorus atom, all corresponding groups which also can be contained in the structural unit (W1) as corresponding functional groups which contain at least one phosphorus atom are suitable. As functional groups which are functional groups reactive towards an isocyanate group, all corresponding groups which also can be contained in the structural unit (W2) as corresponding functional groups are suitable.

The incorporation of the preferably recurring structural unit (W1) into the chemical structure of the homopolymer or copolymer according to the invention can preferably be achieved by means of two different process variants (process variants 1 and 2), with the process variant 2 being preferred. The incorporation of the preferably recurring structural unit (W0) into the chemical structure of the homopolymer or copolymer according to the invention can also be achieved by means of process variant 2.

Process Variant 1

According to process variant 1, the homopolymer or copolymer used according to the invention is preferably obtainable by radical polymerization of
(a) at least one ethylenically unsaturated monomer capable of forming the structural unit (W1) which contains at least one functional group which contains at least one phosphorus atom, at least one ethylenically unsaturated monomer capable of forming the structural unit (W2), which contains at least one, optionally also two, functional groups reactive towards an isocyanate group, preferably at least one, optionally also two, hydroxyl groups, and optionally at least one ethylenically unsaturated monomer capable of forming the structural unit (W3).

Here the incorporation of the structural unit (W1) into the chemical structure of the homopolymer or copolymer used according to the invention is effected in that, for the production of the homopolymer or copolymer used according to the invention, at least one ethylenically unsaturated monomer capable of forming the structural unit (W1) which contains at least one functional group which contains at least one phosphorus atom, is used. In this case, the structural unit (W1) of the homopolymer or copolymer used according to the invention is derived from at least one corresponding ethylenically unsaturated monomer which contains at least one functional group which contains at least one phosphorus atom.

Optionally, the ethylenically unsaturated monomer capable of forming the structure (W1) can additionally contain at least one group reactive towards an isocyanate group such as at least one OH group. Such a monomer is for example a dihydroxyalkyl (meth)acrylate such as 2,3-dihydroxypropyl (meth)acrylate, one OH function whereof, for example in the 2-position, is phosphorylated by means of a phosphorylating agent, whereas the remaining OH function, for example in the 3-position, is a functional group reactive towards an isocyanate group.

Preferably, the structural unit (W1) of the homopolymer or copolymer used according to the invention is derived from at least one ethylenically unsaturated monomer which contains at least one functional group containing at least one phosphorus atom, which is selected from the group consisting of phosphonic acid groups, at least partially esterified phosphonic acid groups, at least partially esterified phosphoric acid groups, and respective corresponding salts of these groups such as for example phosphonates or phosphates.

Particularly preferably, the structural unit (W1) of the homopolymer or copolymer used according to the invention is derived from at least one ethylenically unsaturated monomer, which is selected from the group consisting of
vinylphosphonic acid, vinylphosphonic acid in a form at least partially esterified with a C₁₋₈ alkyl alcohol, vinylphosphoric acid in a form at least partially esterified with a C₁₋₈ alkyl alcohol,
alkyl (meth)acrylates, cycloalkyl (meth)acrylates, aryl (meth)acrylates and alkylaryl (meth)acrylates, wherein the alkyl residues, cycloalkyl residues, aryl residues or alkylaryl residues of these (meth)acrylates can each contain at least one functional group containing at least one phosphorus atom such as a phosphonate or phosphate group, in particular at least one phosphate group, and optionally can each additionally contain at least one group reactive towards an isocyanate group.

Alkyl (meth)acrylates in this respect are preferably alkyl (meth)acrylates of unbranched or branched aliphatic alcohols with 1 to 22, preferably 1 to 12, carbon atoms such as for example methyl (meth)acrylate, ethyl (meth)acrylate, n-butyl (meth)acrylate, i-butyl (meth)acrylate, t-butyl (meth)acrylate, lauryl (meth)acrylate, 2-ethylhexyl (meth)acrylate, stearyl (meth)acrylate, wherein the alkyl residues of these (meth)acrylates can each contain at least one functional group containing at least one phosphorus atom, in particular at least one phosphate group, and optionally can each additionally contain at least one group reactive towards an isocyanate group.

Cycloalkyl (meth)acrylates in this respect are preferably cycloalkyl (meth)acrylates of cycloaliphatic alcohols with 3 to 22, preferably 3 to 12, carbon atoms such as for example cyclohexyl (meth)acrylate or isobornyl (meth)acrylate, wherein the cycloalkyl residues of these (meth)acrylates can each contain at least one functional group containing at least one phosphorus atom, in particular at least one phosphate group, and optionally can each additionally contain at least one group reactive towards an isocyanate group.

Aryl (meth)acrylates in this respect are preferably aryl (meth)acrylates of aromatic alcohols with 6 to 22, preferably 6 to 12, carbon atoms, wherein the aryl residues can each be unsubstituted or up to quadruply substituted, such as for example 4-nitrophenyl methacrylate or phenyl (meth)acrylate, and wherein the aryl residues of these (meth)acrylates can each contain at least one functional group containing at least one phosphorus atom, in particular at least one phosphate group, and optionally can each additionally contain at least one group reactive towards an isocyanate group.

Alkylaryl (meth)acrylates in this respect are preferably alkylaryl (meth)acrylates of alcohols with 6 to 22, preferably 6 to 12, carbon atoms, which contain both an aliphatic and also an aromatic residue, wherein the aryl residues can each be unsubstituted or up to quadruply substituted, such as for example benzyl (meth)acrylate, and wherein the alkylaryl residues of these (meth)acrylates can each contain at least one functional group containing at least one phosphorus atom, in particular at least one phosphate group, and optionally can each additionally contain at least one group reactive towards an isocyanate group.

In the sense of the present invention, the expression “(meth)acryl” in each case includes “methacryl” and/or “acryl”.

Quite especially preferably, the structural unit (W1) of the homopolymer or copolymer used according to the invention is derived from at least one ethylenically unsaturated monomer, which is selected from the group consisting of
Vinylphosphonic acid, vinylphosphonic acid in a form at least partially esterified with a C₁₋₈ alkyl alcohol, vinylphosphoric acid in a form at least partially esterified with a C₁₋₈ alkyl alcohol, 2-(meth)acryloyloxyethyl phosphate, 3-(meth)acryloyloxypropyl phosphate, 4-(meth)acryloyloxybutyl phosphate, 10-methacryloyloxydecyl dihydrogen phosphate, ethyl-2-[4-(dihydroxyphosphoryl)-2-oxabutyl]acrylate and 2,4,6-trimethylphenyl-2-[4-(dihydroxyphosphoryl)-2-oxabutyl]acrylate.

In particular, the structural unit (W1) of the homopolymer or copolymer used according to the invention is particularly preferably derived from at least one ethylenically unsaturated monomer which is selected from the group consisting of
Vinylphosphonic acid, vinylphosphonic acid in a form at least partially esterified with a C₁₋₈ alkyl alcohol such as for example dimethyl vinylphosphonate or diethyl vinylphosphonate, vinylphosphoric acid in a form at least partially esterified with a C₁₋₈ alkyl alcohol, 2-(meth)acryloyloxyethyl phosphate, 3-(meth)acryloyloxypropyl phosphate and 4-(meth)acryloyloxybutyl phosphate.

It is however not absolutely necessary that the incorporation of the structural unit (W1) into the chemical structure of the homopolymer or copolymer used according to the invention is effected in that, for the production of the homopolymer or copolymer by means of a preferably radical polymerization reaction, at least one ethylenically unsaturated monomer is used which as well as at least one existing carbon-carbon double bond additionally contains at least one functional group which contains at least one phosphorus atom (process variant 1). Alternatively, the incorporation of the preferably recurring structural unit (W1), exactly as also the preferably recurring structural unit (W0), into the chemical structure of the homopolymer or copolymer according to the invention can be achieved by means of a second preferred process variant (Process variant 2):

Process Variant 2

Alternatively it is also possible that for the incorporation of the structural unit (W1) or (W0) during the preferably radical polymerization, a corresponding non-phosphorus-containing monomer is used, i.e. at least one ethylenically unsaturated monomer is used which as well as at least one existing carbon-carbon double bond contains no functional group which contains at least one phosphorus atom.

Preferably, the incorporation of the recurring structural unit (W1) or (W0) into the chemical structure of the homopolymer or copolymer used according to the invention is therefore effected in that for the production of the homopolymer or copolymer by means of a preferably radical polymerization reaction, at least one ethylenically unsaturated monomer is used which as well as at least one existing preferably terminal carbon-carbon double bond contains no functional group which contains at least one phosphorus atom, but instead contains at least one functional group which after production of the homopolymer or copolymer is converted into a functional group which contains at least one phosphorus atom preferably by means of a polymer-analogous reaction such as for example a phosphorylation.

In a preferred embodiment, the incorporation of the structural units (W1) and (W2) or (W0) and optionally (W3) into the chemical structure of the copolymer used according to the invention, is effected in that for production of the copolymer by means of a preferably radical polymerization reaction, at least two ethylenically unsaturated monomers different from one another are used, wherein at least one of these monomers as well as at least one existing preferably terminal carbon-carbon double bond contains at least one free or optionally protected OH group, and wherein the free or protected OH groups contained in the copolymer after the copolymerization after their deprotection are optionally partially converted with at least one phosphorylating agent to functional groups which contain at least one phosphorus atom.

In a further preferred embodiment, the incorporation of the structural units (W1) and (W2) or of the structural unit (W0) and (W3) into the chemical structure of the homopolymer or copolymer used according to the invention, is effected in that for the production of the copolymer used according to the invention by means of a preferably radical polymerization reaction, at least one first ethylenically unsaturated monomer is used which as well as at least one existing preferably terminal carbon-carbon double bond contains at least one free or optionally protected OH group, and at least one further ethylenically unsaturated monomer different from the first ethylenically unsaturated monomer, is used which as well as at least one existing preferably terminal carbon-carbon double bond contains neither a free or optionally protected OH group nor a functional group containing at least one phosphorus atom, wherein the free or optionally protected OH groups contained in the homopolymer or copolymer after the polymerization reaction after their deprotection are optionally partially converted with at least one phosphorylating agent to functional groups which contain at least one phosphorus atom.

According to the process variant 2, the homopolymer or copolymer used according to the invention is preferably obtainable by radical polymerization of
(b1) at least two ethylenically unsaturated monomers different from each other capable of forming the structural unit (W2), which each mutually independently contain at least one functional group reactive towards an isocyanate group, preferably each mutually independently contain at least one optionally protected hydroxyl group and/or at least one optionally protected carboxyl group, and optionally at least one ethylenically unsaturated monomer capable of forming the structural unit (W3),
   or
   of at least one ethylenically unsaturated monomer capable of forming the structural unit (W2), which contains at least one functional group reactive towards an isocyanate group, preferably at least one optionally protected hydroxyl group, and at least one ethylenically unsaturated monomer capable of forming the structural unit (W3),
and
(b2) partial conversion, preferably by phosphorylation, of the functional groups reactive towards isocyanate groups, preferably hydroxyl groups, contained in the structural units (W2) of the homopolymer or copolymer obtainable according to step (b1) into functional groups which contain at least one phosphorus atom, for the formation of structural units (W1) or (W0) within the homopolymer or copolymer.

The reactive hydroxyl group or carboxyl group here can in each case also be present in protected form.

The structural unit (W0) can alternatively also be obtained by radical copolymerization of
(c) at least one ethylenically unsaturated monomer capable of forming the structural unit (W0), which both contains at least one functional group which contains at least one phosphorus atom, and also contains at least one functional group reactive towards an isocyanate group, and optionally at least one ethylenically unsaturated monomer capable of forming the structural unit (W3).

According to the process variant 2, the homopolymer or copolymer used according to the invention is particularly preferably obtainable by radical polymerization of
(b1a) at least two ethylenically unsaturated monomers different from each other capable of forming the structural unit (W2), which each contain at least one optionally protected hydroxyl group reactive towards an isocyanate group, and optionally at least one ethylenically unsaturated monomer capable of forming the structural unit (W3), or of
   at least one ethylenically unsaturated monomer capable of forming the structural unit (W2), which contains at least one optionally protected hydroxyl group reactive towards an isocyanate group, and at least one ethylenically unsaturated monomer capable of forming the structural unit (W3),
and
(b2a) partial phosphorylation of the hydroxyl groups contained in the structural units (W2) of the homopolymer or copolymer obtainable according to step (b1a) for the formation of structural units (W1) or (W0) within the homopolymer or copolymer.

The reactive hydroxyl group here can in each case also be present in protected form.

The ethylenically unsaturated monomer capable of forming the structural unit (W2) used according to the process variant 2 in step (b1) or (b1a) can here contain as at least one functional group reactive towards an isocyanate group a corresponding group which is present in free form or protected by means of a protective group. The protective group is preferably removed during or before implementation of the step (b2) or (b2a). Suitable protective groups are known to those skilled in the art.

The ethylenically unsaturated monomer capable of forming the structural unit (W2) used according to the process variant 2 in step (b1) or (b1a) can here also contain two functional groups reactive towards an isocyanate group, such as for example two OH groups, at least one or both of which can be phosphorylated in step (b2).

Step (b2) or (b2a) is preferably performed with at least one phosphorylating agent. Any usual phosphorylating agent known to those skilled in the art can be used here. Preferred phosphorylating agents used according to the invention are selected from the group consisting of phosphorus pentoxide (P₄O₁₀), phosphoric acid, polyphosphoric acid and phosphorus oxychloride.

Here the phosphorylating agent is preferably used in molar proportions such that the functional groups reactive towards isocyanate groups such as for example hydroxyl groups contained in the homopolymer or copolymer which is preferably obtainable according to step (b1) or (b1a) are only partially phosphorylated, so that the homopolymer or copolymer used according to the invention is composed of at least both of structural units (W1) and also (W2) or of at least one structural unit (W0).

Preferably, the structural unit (W1) or (W0) of the homopolymer or copolymer used according to the invention obtainable according to Process variant 2 is derived from at least one ethylenically unsaturated monomer which is selected from the group consisting of

alkyl (meth)acrylates, cycloalkyl (meth)acrylates, aryl (meth)acrylates and alkylaryl (meth)acrylates, wherein the alkyl residues, cycloalkyl residues, aryl residues or alkylaryl residues of these (meth)acrylates each contain at least one OH group or at least one protected OH group,

Alkyl(meth)acrylamides, cycloalkyl(meth)acrylamides, aryl(meth)acrylamides and alkylaryl(meth)acrylamides, wherein the alkyl residues, cycloalkyl residues, aryl residues or alkylaryl residues of these (meth)acrylamides in each case contain at least one OH group or at least one protected OH group,

allyl alcohol, vinyl alcohol, hydroxyalkyl vinyl ethers and hydroxyalkyl allyl ethers,

wherein the OH groups after production of the homopolymer or copolymer preferably obtainable according to step (b1) or (b1a) after their deprotection are optionally partially converted with at least one phosphorylating agent.

Alkyl (meth)acrylates in this respect are preferably alkyl (meth)acrylates of unbranched or branched aliphatic alcohols with 2 to 36, preferably 2 to 22, particularly preferably 2 to 12, carbon atoms such as for example methyl (meth)-acrylate, ethyl (meth)acrylate, n-butyl (meth)acrylate, i-butyl (meth)acrylate, t-butyl (meth)acrylate, lauryl (meth)acrylate, 2-ethylhexyl (meth)acrylate and stearyl (meth)acrylate, wherein the alkyl residues of these (meth)acrylates each contain at least one OH group or at least one protected OH group.

Cycloalkyl (meth)acrylates in this respect are preferably cycloalkyl (meth)acrylates of cycloaliphatic alcohols with 3 or 4 to 22, preferably 3 or 4 to 12, carbon atoms such as for example cyclohexyl (meth)acrylate or isobornyl (meth)acrylate, wherein the cycloalkyl residues of these (meth)acrylates each contain at least one OH group or at least one protected OH group.

Aryl (meth)acrylates in this respect are preferably aryl (meth)acrylates of aromatic alcohols with 6 to 22, preferably 6 to 12, carbon atoms, wherein the aryl residues can each be unsubstituted or up to quadruply substituted, such as for example 4-nitrophenyl methacrylate or phenyl (meth)acrylate, and wherein the aryl residues of these (meth)acrylates each contain at least one OH group or at least one protected OH group.

Alkylaryl (meth)acrylates in this respect are preferably alkylaryl (meth)acrylates of alcohols with 6 to 22, preferably 6 to 12, carbon atoms, which contain both an aliphatic and also an aromatic residue, wherein the aryl residues can each be unsubstituted or up to quadruply substituted, such as for example benzyl (meth)acrylate, and wherein the alkylaryl residues of these (meth)acrylates each contain at least one OH group or at least one protected OH group.

Hydroxyalkyl vinyl ethers and hydroxyalkyl allyl ethers preferably have an alkyl chain with 2 to 36, preferably 2 to 12, carbon atoms. Hydroxyalkyl vinyl ethers are preferred to hydroxyalkyl allyl ethers.

Particularly preferably, the structural unit (W1) or (W0) of the homopolymer or copolymer used according to the invention obtainable according to process variant 2 is derived from at least one ethylenically unsaturated monomer which is selected from the group consisting of

alkyl (meth)acrylates, wherein the alkyl residues of these (meth)acrylates each contain at least one OH group or at least one protected OH group, in particular selected from the group consisting of hydroxyethyl (meth)acrylate, hydroxypropyl (meth)acrylate and hydroxybutyl (meth)acrylate,

wherein the OH groups after production of the homopolymer or copolymer preferably obtainable according to step (b1) or (b1a), after their deprotection, are optionally partially converted with at least one phosphorylating agent.

Hydroxyethyl (meth)acrylate according to the invention preferably includes both 1-hydroxyethyl (meth)acrylate and also 2-hydroxyethyl (meth)acrylate. Hydroxypropyl (meth)acrylate according to the invention preferably includes both 2-hydroxypropyl (meth)acrylate and also 3-hydroxypropyl (meth)acrylate. Hydroxybutyl (meth)acrylate according to the invention preferably includes both 1-hydroxybutyl (meth)acrylate, 2-hydroxybutyl (meth)acrylate, 3-hydroxybutyl (meth)acrylate and also 4-hydroxybutyl (meth)acrylate.

The ethylenically unsaturated monomers each containing at least one optionally protected OH group used here for the incorporation of the structural unit (W1) or (W0) into the homopolymer or copolymer obtainable according to the invention according to process variant 2 can each also be used in chain-extended form: examples of chain-extended variants of the ethylenically unsaturated monomers each containing at least one optionally protected OH group are

(i) alkoxylated forms of these monomers, which are for example obtainable by reaction of said monomers with ethylene oxide, propylene oxide and/or butylene oxide, in particular with ethylene oxide and/or propylene oxide, or by reactions with glycidol,

(ii) forms chain-extended with lactones, which are for example obtainable by conversion of the OH function of the monomers by a ring-opening polymerization with lactones, in particular c-caprolactone and/or δ-valerolactone, with obtention of caprolactone- and/or valerolactone-modified monomers, in particular corresponding caprolactone- and/or valerolactone-modified hydroxyalkyl (meth)acrylates such as caprolactone- and/or valerolactone-modified hydroxyethyl (meth)acrylate, hydroxypropyl (meth)acrylate and/or hydroxybutyl (meth)acrylate, which preferably have a number average molecular weight from 220 to 1200 g/mol, and

(iii) reactions with oxetanes such as 3-ethyl-3-(hydroxymethyl)oxacyclobutane, which can also lead to branched structures.

Combinations of such chain extensions (e.g. firstly alkoxylation and subsequent reaction with lactones) is also possible.

In a quite especially preferred embodiment, the structural unit (W1) of the homopolymer or copolymer used according to the invention is derived

according to process variant 1 from at least one ethylenically unsaturated monomer which is selected from the group consisting of

vinylphosphonic acid, vinylphosphonic acid in a form at least partially esterified with a C₁₋₈ alkyl alcohol such as for example dimethyl vinylphosphonate or diethyl vinylphosphonate, vinylphosphoric acid in a form at least partially esterified with a C₁₋₈ alkyl alcohol, alkyl (meth)acrylates, cycloalkyl (meth)acrylates, aryl (meth)-acrylates and alkylaryl (meth)acrylates, wherein the alkyl residues, cycloalkyl residues, aryl residues or alkylaryl residues of these (meth)acrylates each contain at least one functional group containing at least one phosphorus atom, in particular at least one phosphate group,

and the structural unit (W1) or (W0) according to process variant 2 from at least one ethylenically unsaturated monomer which is selected from the group consisting of

alkyl (meth)acrylates, cycloalkyl (meth)acrylates, aryl (meth)acrylates and alkylaryl (meth)acrylates, wherein the alkyl residues, cycloalkyl residues, aryl residues or alkylaryl residues of these (meth)acrylates each contain at least one OH group or at least one protected OH group, in particular hydroxyethyl (meth)acrylate, hydroxypropyl (meth)acrylate and hydroxybutyl (meth)acrylate,

alkyl(meth)acrylamides, cycloalkyl(meth)acrylamides, aryl(meth)acrylamides and alkylaryl(meth)acrylamides, wherein the alkyl residues, cycloalkyl residues, aryl residues or alkylaryl residues of these (meth)acrylamides each contain at least one OH group or at least one protected OH group,

allyl alcohol, vinyl alcohol, hydroxyalkyl vinyl ethers and hydroxyalkyl allyl ethers,

wherein the OH groups after production of the homopolymer or copolymer preferably obtainable according to step (b1) or (b1a), optionally after their deprotection, are partially converted with at least one phosphorylating agent.

The structural unit (W0) can preferably alternatively also be obtained by radical polymerization of
at least one ethylenically unsaturated monomer selected from the group consisting of alkyl (meth)acrylates, cycloalkyl (meth)acrylates, aryl (meth)acrylates and alkylaryl (meth)acrylates, wherein the alkyl residues, cycloalkyl residues, aryl residues or alkylaryl residues of these (meth)acrylates each contain both at least one functional group containing at least one phosphorus atom and also at least one OH group or at least one protected OH group, for the formation of structural units (W0) within the homopolymer or copolymer.

In particular, the structural unit (W0) can be obtained by radical polymerization of at least one ethylenically unsaturated monomer selected from the group consisting of [(3-(meth)acryloyloxy-2-hydroxypropyl)]phosphate and [(2-(meth)acryloyloxy-3-hydroxypropyl)]phosphate, in particular [(2-(meth)acryloyloxy-3-hydroxypropyl)]phosphate for the formation of structural units (W0) within the homopolymer or copolymer.

Structural Unit (W2)

Each structural unit (W2) within the homopolymer or copolymer used according to the invention contains at least one functional group reactive towards an isocyanate group.

Preferably, each structural unit (W2), as at least one functional group reactive towards an isocyanate group, contains at least one group selected from the group consisting of optionally protected hydroxyl groups, in particular free hydroxyl groups, thiol groups, epoxide groups, carboxyl groups, optionally protected primary amino groups and optionally protected secondary amino groups, particularly preferably selected from the group consisting of optionally protected hydroxyl groups, in particular free hydroxyl groups, epoxide groups, optionally protected primary amino groups and optionally protected secondary amino groups and quite especially preferably selected from the group consisting of optionally protected hydroxyl groups and optionally protected primary amino groups and optionally protected secondary amino groups, in particular hydroxyl groups.

Preferably, 70 to 100 mol. % of the at least one functional group reactive towards an isocyanate group of each of the structural units (W2) of the homopolymer or copolymer are each mutually independently selected from the group consisting of optionally protected hydroxyl groups, in particular free hydroxyl groups, thiol groups, epoxide groups, carboxyl groups, optionally protected primary amino groups and optionally protected secondary amino groups, particularly preferably selected from the group consisting of optionally protected hydroxyl groups, in particular free hydroxyl groups, epoxide groups, optionally protected primary amino groups and optionally protected secondary amino groups and quite especially preferably selected from the group consisting of optionally protected hydroxyl groups and optionally protected primary amino groups and optionally protected secondary amino groups, in particular hydroxyl groups.

Preferably, the incorporation of the structural unit (W2) into the chemical structure of the homopolymer or copolymer used according to the invention is effected in that for the production of the homopolymer or copolymer according to the invention by means of a preferably radical polymerization reaction, in which at least one ethylenically unsaturated monomer is used which as well as at least one existing preferably terminal carbon-carbon double bond additionally contains at least one functional group reactive towards an isocyanate group. Preferably, the structural unit (W2) of the homopolymer or copolymer used according to the invention is therefore derived from at least one ethylenically unsaturated monomer which contains at least one functional group reactive towards an isocyanate group selected from the group consisting of OH groups, primary amino groups, secondary amino groups, thiol groups, epoxide groups and carboxyl groups. Quite especially preferably, the at least one functional group reactive towards an isocyanate group is here selected from the group consisting of OH groups and carboxyl groups, in particular OH groups.

Preferably, the structural unit (W2) of the homopolymer or copolymer used according to the invention is derived from at least one ethylenically unsaturated monomer which is selected from the group consisting of

alkyl (meth)acrylates, cycloalkyl (meth)acrylates, aryl (meth)acrylates and alkylaryl (meth)acrylates, wherein the alkyl residues, cycloalkyl residues, aryl residues or alkylaryl residues of these (meth)acrylates each contain at least one OH group or at least one protected OH group,

alkyl(meth)acrylamides, cycloalkyl(meth)acrylamides, aryl(meth)acrylamides and alkylaryl(meth)acrylamides, wherein the alkyl residues, cycloalkyl residues, aryl residues or alkylaryl residues of these (meth)acrylamides each contain at least one OH group or at least one protected OH group,

allyl alcohol, vinyl alcohol, hydroxyalkyl vinyl ethers and hydroxyalkyl allyl ethers.

Here the same respective monomers can preferably be used which can also be used for the incorporation of the structural unit (W1) or (W0) in the homopolymer or copolymer used according to the invention according to process variant 2.

Alkyl (meth)acrylates in this respect are preferably alkyl (meth)acrylates of unbranched or branched aliphatic alcohols with 2 to 36, preferably 2 to 22, particularly preferably 2 to 12, carbon atoms such as for example methyl (meth)-acrylate, ethyl (meth)acrylate, n-butyl (meth)acrylate, i-butyl (meth)acrylate, t-butyl (meth)acrylate, lauryl (meth)acrylate, 2-ethylhexyl (meth)acrylate and stearyl (meth)acrylate, wherein the alkyl residues of these (meth)acrylates each contain at least one OH group or at least one protected OH group.

Cycloalkyl (meth)acrylates in this respect are preferably cycloalkyl (meth)acrylates of cycloaliphatic alcohols with 3 to 22, preferably 3 to 12, carbon atoms such as for example cyclohexyl (meth)acrylate or isobornyl (meth)acrylate, wherein the cycloalkyl residues of these (meth)acrylates each contain at least one OH group or at least one protected OH group.

Aryl (meth)acrylates in this respect are preferably aryl (meth)acrylates of aromatic alcohols with 6 to 22, preferably 6 to 12, carbon atoms, wherein the aryl residues can each be unsubstituted or up to quadruply substituted, such as for example 4-nitrophenyl methacrylate or phenyl (meth)acrylate, and wherein the aryl residues of these (meth)acrylates each contain at least one OH group or at least one protected OH group.

Alkylaryl (meth)acrylates in this respect are preferably alkylaryl (meth)acrylates of alcohols with 6 to 22, preferably 6 to 12, carbon atoms, which contain both an aliphatic and also an aromatic residue, wherein the aryl residues can each be unsubstituted or up to quadruply substituted, such as for example benzyl (meth)acrylate, and wherein the alkylaryl residues of these (meth)acrylates each contain at least one OH group or at least one protected OH group.

Hydroxyalkyl vinyl ethers and hydroxyalkyl allyl ethers preferably contain an alkyl chain with 2 to 36, preferably 2 to 12, carbon atoms. Hydroxyalkyl vinyl ethers are preferred to hydroxyalkyl allyl ethers.

Particularly preferably, the structural unit (W2) of the homopolymer or copolymer used according to the invention is derived from at least one ethylenically unsaturated monomer which is selected from the group consisting of

alkyl (meth)acrylates, wherein the alkyl residues, of these (meth)acrylate each contain at least one OH group or at least one protected OH group, most preferably selected from the group consisting of hydroxyethyl (meth)acrylate, hydroxypropyl (meth)acrylate and hydroxybutyl (meth)acrylate.

The ethylenically unsaturated monomers each containing at least one optionally protected OH group used here for the incorporation of the structural unit (W2) into the homopolymer or copolymer used according to the invention can each also be used in chain-extended form: examples of chain-extended variants of the ethylenically unsaturated monomers each containing at least one optionally protected OH group are

(i) alkoxylated forms of these monomers, which are for example obtainable by reaction of said monomers with ethylene oxide, propylene oxide and/or butylene oxide, in particular with ethylene oxide and/or propylene oxide or by reactions with glycidol,

(ii) forms chain-extended with lactones, which are for example obtainable by conversion of the OH function of the monomers by means of a ring-opening polymerization with lactones, in particular c-caprolactone and/or δ-valerolactone, with obtention of caprolactone- and/or valerolactone-modified monomers, in particular corresponding caprolactone- and/or valerolactone-modified hydroxyalkyl (meth)acrylates such as caprolactone- and/or valerolactone-modified hydroxyethyl (meth)acrylate, hydroxypropyl (meth)acrylate and/or hydroxybutyl (meth)acrylate, which preferably have a number average molecular weight from 220 to 1200 g/mol, and

(iii) reactions with oxetanes such as 3-ethyl-3-(hydroxymethyl)oxacyclobutane, which can also lead to branched structures.

Combinations of such chain extensions (e.g. firstly alkoxylation and subsequent reaction with lactones) are also possible.

In another preferred embodiment, the structural unit (W2) of the homopolymer or copolymer according to the invention is derived from at least one ethylenically unsaturated monomer which contains at least one functional carboxyl group reactive towards an isocyanate group and which is preferably selected from the group consisting of

(meth)acrylic acid, carboxyethyl (meth)acrylate, itaconic acid, fumaric acid, maleic acid, citraconic acid, crotonic acid, cinnamic acid and unsaturated fatty acids with preferably 12 to 22 carbon atoms, which can each optionally, if they contain more than one carboxyl group, also be present in a partially esterified form, wherein a C₁₋₁₀ alcohol can preferably be used for the partial esterification.

Preferably, the structural unit (W2) of the homopolymer or copolymer according to the invention is derived from at least one ethylenically unsaturated monomer which contains at least one functional carboxyl group reactive towards an isocyanate group and which is selected from the group consisting of acrylic acid and methacrylic acid.

In a further preferred embodiment, the structural unit (W2) of the homopolymer or copolymer according to the invention is derived from at least one ethylenically unsaturated monomer which contains at least one functional amino group reactive towards an isocyanate group, optionally in protected form, and which is preferably selected from the group consisting of

alkyl (meth)acrylates, cycloalkyl (meth)acrylates, aryl (meth)acrylates and alkylaryl (meth)acrylates, wherein the alkyl residues, cycloalkyl residues, aryl residues or alkylaryl residues of these (meth)acrylates each contain at least one primary or secondary, preferably at least one secondary amino group,

alkyl(meth)acrylamides, cycloalkyl(meth)acrylamides, aryl(meth)acrylamides and alkylaryl(meth)acrylamides, wherein the alkyl residues, cycloalkyl residues, aryl residues or alkylaryl residues of these (meth)acrylamides each contain at least one primary or secondary, preferably at least one secondary amino group,

allylamine, vinylformamide (which is convertible into vinylamine repeating units by polymer-analogous reaction), aminoalkyl vinyl ethers and aminoalkyl allyl ethers.

Alkyl (meth)acrylates in this respect are preferably alkyl (meth)acrylates of unbranched or branched aliphatic alcohols with 2 to 36, preferably 2 to 22, particularly preferably 2 to 12, carbon atoms such as for example methyl (meth)-acrylate, ethyl (meth)acrylate, n-butyl (meth)acrylate, i-butyl (meth)acrylate, t-butyl (meth)acrylate, lauryl (meth)acrylate, 2-ethylhexyl (meth)acrylate and stearyl (meth)acrylate, wherein the alkyl residues of these (meth)acrylates each contain at least primary or secondary, preferably at least one secondary amino group.

Cycloalkyl (meth)acrylates in this respect are preferably cycloalkyl (meth)acrylates of cycloaliphatic alcohols with 3 to 22, preferably 3 to 12, carbon atoms such as for example cyclohexyl (meth)acrylate or isobornyl (meth)acrylate, wherein the cycloalkyl residues of these (meth)acrylates each contain at least one primary or secondary, preferably at least one secondary amino group.

Aryl (meth)acrylates in this respect are preferably aryl (meth)acrylates of aromatic alcohols with 6 to 22, preferably 6 to 12, carbon atoms, wherein the aryl residues can each be unsubstituted or up to quadruply substituted and wherein the aryl residues of these (meth)acrylates each contain at least one primary or secondary, preferably at least one secondary amino group.

Alkylaryl (meth)acrylates in this respect are preferably alkylaryl (meth)acrylates of alcohols with 6 to 22, preferably 6 to 12, carbon atoms, which contain both an aliphatic and also an aromatic residue, wherein the aryl residues can each be unsubstituted or up to quadruply substituted, such as for example benzyl (meth)acrylate, and wherein the alkylaryl residues of these (meth)acrylates each contain at least one primary or secondary, preferably at least one secondary amino group.

Particularly preferably, the structural unit (W2) of the homopolymer or copolymer used according to the invention is derived from at least one ethylenically unsaturated monomer which is selected from the group consisting of

alkyl (meth)acrylates, wherein the alkyl residues of these (meth)acrylates each contain at least one primary or secondary, preferably at least one secondary amino group, most preferably selected from the group consisting of N-alkylaminoethyl (meth)acrylates, N-alkylaminopropyl (meth)acrylates and N-alkylaminobutyl (meth)-acrylates, wherein N-alkyl residues in particular are linear or branched C₁₋₈ alkyl residues; particularly preferred is N-tert-butyl-aminoethyl (meth)acrylate.

In a further particularly preferred embodiment, the structural unit (W2) of the homopolymer or copolymer according to the invention is derived from at least one ethylenically unsaturated monomer which contains at least one functional carboxyl group reactive towards an isocyanate group or at least one functional hydroxyl group reactive towards an isocyanate group, and which is preferably selected from the group consisting of

alkyl (meth)acrylates, cycloalkyl (meth)acrylates, aryl (meth)acrylates and alkylaryl (meth)acrylates, wherein the alkyl residues, cycloalkyl residues, aryl residues or alkylaryl residues of these (meth)acrylates each contain at least one OH group or at least one protected OH group,

alkyl(meth)acrylamides, cycloalkyl(meth)acrylamides, aryl(meth)acrylamides and alkylaryl(meth)acrylamides, wherein the alkyl residues, cycloalkyl residues, aryl residues or alkylaryl residues of these (meth)acrylamides each contain at least one OH group or at least one protected OH group,

allyl alcohol, vinyl alcohol, hydroxyalkyl vinyl ethers and hydroxyalkyl allyl ethers,

in particular alkyl (meth)acrylates, wherein the alkyl residues of these (meth)acrylates each contain at least one OH group or at least one protected OH group, for example hydroxyethyl (meth)acrylate, hydroxypropyl (meth)acrylate and/or hydroxybutyl (meth)acrylate,

(meth)acrylic acid, carboxyethyl (meth)acrylate, itaconic acid, fumaric acid, maleic acid, citraconic acid, crotonic acid, cinnamic acid and unsaturated fatty acids with preferably 12 to 22 carbon atoms, which can each optionally, if they contain more than one carboxyl group, also be present in a partially esterified form, wherein a C₁₋₁₀ alcohol can preferably be used for the partial esterification.

It is however not absolutely necessary that the incorporation of the structural unit (W2) into the chemical structure of the homopolymer or copolymer used according to the invention is effected in that, for the production of the homopolymer or copolymer by means of a preferably radical polymerization reaction, at least one ethylenically unsaturated monomer is used which as well as at least one existing carbon-carbon double bond additionally contains at least one functional group reactive towards an isocyanate group.

Alternatively, it is also possible that at least one monomer is used in the polymerization, i.e. at least one ethylenically unsaturated monomer is used, which does not contain at least one functional group reactive towards an isocyanate group such as for example an OH group. The at least one functional group reactive towards an isocyanate group contained in (W2) can in this case be incorporated into the homopolymer or copolymer structure by means of a polymer-analogous reaction only after preferably radical polymerization reaction, in which at least one ethylenically unsaturated monomer is used, has taken place.

A particularly preferable variant of this method is the production of the homopolymer or copolymer used according to the invention by use of at least one ethylenically unsaturated compound with at least one OH group protected by means of an ester group in the polymerization, which then, after its deprotection, for example by a hydrolysis reaction of the ester group, is a functional group reactive towards an isocyanate group, namely a free OH group.

A further preferred variant of this method is the production of the homopolymer or copolymer used according to the invention by use of at least one ethylenically unsaturated compound with at least one epoxide group, such as for example with use of glycidyl (meth)acrylate, in the polymerization, which then, for example by a ring opening reaction by means of a suitable amine, can be converted into a free OH group. This is shown schematically below by way of example:

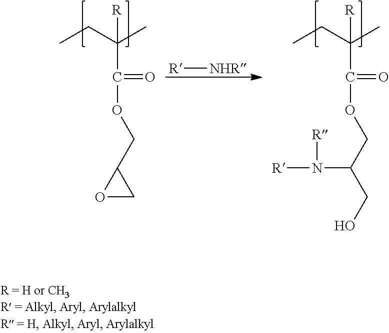

A further preferred variant of this method is the production of the homopolymer or copolymer used according to the invention by use of at least one ethylenically unsaturated compound with at least one anhydride group, such as for example by use of maleic anhydride, in the polymerization, which can then be converted, for example by a reaction with a suitable amino alcohol, to a free OH group, i.e. a functional group reactive towards an isocyanate group. Depending on the reaction conditions, in the process an amide, diamide or imide group containing at least one OH group is formed within the copolymer according to the invention. This is shown schematically below by way of example:

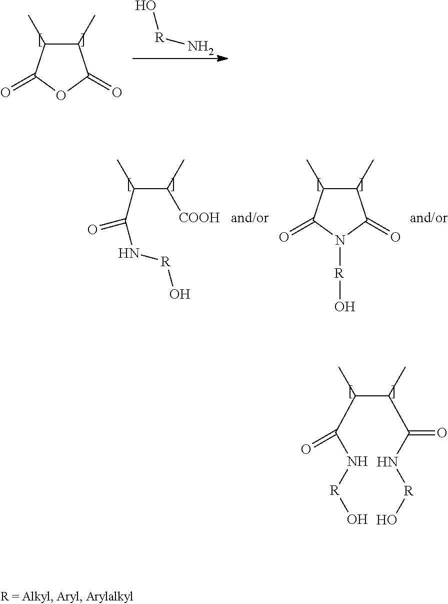

Structural Unit (W3)

The homopolymer or copolymer used according to the invention comprises at least two mutually different structural units (W1) and (W2) or at least one structural unit (W0). Preferably, the homopolymer or copolymer used according to the invention comprises at least one third structural unit (W3), which is different from the structural units (W1) and (W2) or (W0). In this case, the homo- or copolymer used according to the invention is a copolymer. Through the chemical nature of the third structural unit (W3), the compatibility of the copolymer with lacquer systems such as certain coating compositions, in which the copolymer is intended to be used as an adhesion-strengthening additive, can for example be specifically adjusted.

Preferably, the incorporation of the structural unit (W3) into the chemical structure of the copolymer used according to the invention is effected in that, for the production of the copolymer by means of a preferably radical polymerization reaction, at least one ethylenically unsaturated monomer is used which as well as at least one existing carbon-carbon double bond contains none of the functional groups of the structural units (W1) and (W2) or (W0). The further structural unit (W3) is different from the structural units (W1) and (W2) or (W0) and preferably contains no functional group reactive towards an isocyanate group and preferably contains no functional group which contains at least one phosphorus atom. The structural unit (W3) can be basic or neutral. For the case when it is basic, the structural unit (W3) preferably contains tertiary amino groups, i.e. amino groups unreactive towards isocyanate groups. Preferably the structural units (W3) within the copolymer are neutral, i.e. they contain neither acidic nor basic groupings.

Preferably, the structural unit (W3) different from (W1) and (W2) or (W0) is derived from an ethylenically unsaturated monomer, particularly preferably from a (meth)acrylate monomer or a (meth)acrylate-containing monomer, which, when it is used as monomer for the production of a homopolymer obtainable therefrom, forms a homopolymer which has a glass transition temperature (T_{g}) of less than 50° C., particularly preferably of less than 25° C. The term glass transition temperature and methods for the determination of the glass transition temperature are known to those skilled in the art, for example from P. Peyer, Glass transition temperatures of polymers, 1989, Wiley VCH Verlag. Preferably, the determination of the glass transition temperature is performed by differential scanning calorimetry (DSC) according to ISO 11357-2.

Preferably, the incorporation of the structural unit (W3) into the chemical structure of the copolymer used according to the invention, is effected in that for the production of the copolymer by means of a preferably radical polymerization reaction at least one ethylenically unsaturated monomer is used, which is selected from the group consisting of

alkyl (meth)acrylates, cycloalkyl (meth)acrylates, aryl (meth)acrylates, heteroaryl (meth)acrylates and alkylaryl (meth)acrylates, wherein the alkyl residues, cycloalkyl residues, aryl residues, heteroaryl residues or alkylaryl residues of these (meth)acrylates can optionally each contain at least one tertiary amino group and/or at least one alkoxy group,

alkyl(meth)acrylamides such as for example (meth)acrylamide, cycloalkyl-(meth)acrylamides, aryl(meth)acrylamides and alkylaryl(meth)acrylamides, wherein the alkyl residues, cycloalkyl residues, aryl residues or alkylaryl residues of these (meth)acrylamides can optionally contain at least one tertiary amino group such as for example in the case of N,N-dimethylaminopropyl(meth)acrylamide,

Mono(meth)acrylates of oligomeric or polymeric ethers with no free OH group, (meth)acrylates of halogenated alcohols, oxirane-containing (meth)acrylates, styrene and substituted styrenes, wherein the styrenes are not substituted with isocyanate-reactive groups, preferably alpha-methylstyrene and/or or 4-methylstyrene, (meth)acrylonitrile, vinyl group-containing non-basic, cycloaliphatic heterocyclic compounds with at least one N atom as a ring member, such as for example N-vinyl-pyrrolidone and/or N-vinylcaprolactam, vinyl group-containing non-basic, heteroaromatic compounds with at least one N atom as a ring member, such as for example 4-vinylpyridine, 2-vinylpyridine or vinylimidazole, vinyl esters of monocarboxylic acids, preferably of monocarboxylic acids with 1 to 20 carbon atoms, such as for example vinyl acetate, maleic anhydride and diesters thereof, maleimides, e.g. N-phenylmaleinimide and N-substituted maleimides with unbranched, branched or cycloaliphatic alkyl groups with preferably 1 to 22 carbon atoms, wherein however no isocyanate-reactive groups are possible as substituents, particularly preferably N-ethylmaleinimide and/or N-octylmaleinimide and N-alkyl- and N,N-dialkyl substituted acrylamides with unbranched or branched aliphatic or cycloaliphatic alkyl groups with preferably 1 to 22 carbon atoms, for example N-(t-butyl)-acrylamide.

Alkyl (meth)acrylates in this respect are preferably alkyl (meth)acrylates of unbranched or branched, saturated or unsaturated aliphatic alcohols with 2 to 36, preferably 2 to 22, particularly preferably 2 to 12, carbon atoms such as for example methyl (meth)acrylate, ethyl (meth)acrylate, n-butyl (meth)acrylate, i-butyl (meth)acrylate, t-butyl (meth)acrylate, lauryl (meth)acrylate, 2-ethylhexyl (meth)acrylate, stearyl (meth)acrylate, allyl (meth)acrylate or tridecyl (meth)acrylate. Optionally, the alkyl group of these (meth)acrylates can be substituted with at least one tertiary amino group such as for example in the case of N,N-dimethylaminoethyl (meth)acrylate or N,N-dimethylaminopropyl (meth)acrylate and/or at least one alkoxy group such as for example in the case of methoxyethoxyethyl (meth)acrylate, 1-butoxypropyl (meth)acrylate, cyclohexyloxymethyl (meth)acrylate, methoxy-methoxyethyl (meth)acrylate, benzyloxymethyl (meth)acrylate, 2-butoxyethyl (meth)acrylate, 2-ethoxyethyl (meth)acrylate, allyloxymethyl (meth)acrylate, 1-ethoxy-butyl (meth)acrylate, 1-ethoxyethyl (meth)acrylate, and ethoxymethyl (meth)acrylate.

Cycloalkyl (meth)acrylates in this respect are preferably cycloalkyl (meth)acrylates of cycloaliphatic alcohols with 3 to 22, preferably 3 to 12, carbon atoms such as for example cyclohexyl (meth)acrylate or isobornyl (meth)acrylate. Optionally, the cycloalkyl group of these (meth)acrylates can be substituted with at least one tertiary amino group and/or at least one alkoxy group.

Aryl (meth)acrylates in this respect are preferably aryl (meth)acrylates of aromatic alcohols with 6 to 22, preferably 6 to 12, carbon atoms, wherein the aryl residues can each be unsubstituted or up to quadruply substituted, however not with isocyanate-reactive groups, such as for example 4-nitrophenyl methacrylate or phenyl (meth)acrylate. Optionally, the aryl group of these (meth)acrylates can be substituted with at least one tertiary amino group and/or at least one alkoxy group.

Heteroaryl (meth)acrylates in this respect are preferably heteroaryl (meth)acrylates of aromatic alcohols with 6 to 22, preferably 6 to 12, carbon atoms, wherein the heteroaryl residues can each be unsubstituted or up to quadruply substituted, however not with isocyanate-reactive groups, such as for example furfuryl (meth)acrylate. Optionally, the heteroaryl group of these (meth)acrylates can be substituted with at least one tertiary amino group and/or at least one alkoxy group.

Alkylaryl (meth)acrylates in this respect are preferably alkylaryl (meth)acrylates of alcohols with 6 to 22, preferably 6 to 12, carbon atoms, which contain both an aliphatic and also an aromatic residue, wherein the aryl residues can each be unsubstituted or up to quadruply substituted, however not with isocyanate-reactive groups, such as for example benzyl (meth)acrylate. Optionally, the alkyl- and/or aryl group of these (meth)acrylates can be substituted with at least one tertiary amino group and/or at least one alkoxy group.

Mono(meth)acrylates of oligomeric or polymeric ethers with no free OH group in this respect are preferably selected from the group consisting of end-capped polyethylene glycols, polypropylene glycols and mixed polyethylene/propylene glycols, for example poly(ethylene glycol) methyl ether (meth)acrylate and/or poly(propylene glycol) methyl ether(meth)acrylate.

(Meth)acrylates of halogenated alcohols in this respect are preferably perfluoroalkyl (meth)acrylates with 6 to 20 carbon atoms.

Particularly preferably, the incorporation of the structural unit (W3) into the chemical structure of the copolymer used according to the invention is effected in that, for the production of the copolymer by means of a preferably radical polymerization reaction, at least one ethylenically unsaturated monomer is used, which is selected from the group consisting of

alkyl (meth)acrylates, cycloalkyl (meth)acrylates, aryl (meth)acrylates, heteroaryl (meth)acrylates and alkylaryl (meth)acrylates, wherein the alkyl residues, cycloalkyl residues, aryl residues, heteroaryl residues or alkylaryl residues of these (meth)acrylates can optionally each contain at least one tertiary amino group and/or at least one alkoxy group.

Preferably, the structural unit (W3) of the copolymer used according to the invention is derived from at least one ethylenically unsaturated monomer selected from the group consisting of alkyl (meth)acrylates, aryl (meth)acrylates and arylalkyl (meth)acrylates, wherein the alkyl residues, or aryl residues, or alkylaryl residues of these (meth)acrylates can optionally each contain at least one tertiary amino group and/or at least one alkoxy group.

In a preferred embodiment, the incorporation of the structural unit (W3) into the chemical structure of the copolymer used according to the invention is effected in that, for the production of the copolymer by means of a preferably radical polymerization reaction, at least one ethylenically unsaturated monomer is used which is selected from the group consisting of ethylenically unsaturated, preferably aliphatic monomers, which optionally contain each at least one tertiary amino group and/or at least one vinyl group-containing, preferably aromatic heterocycles with at least one protonatable N atom as a ring member, provided no reactivity of this heterocycle towards isocyanate groups is present.

In a further preferred embodiment, the incorporation of the structural unit (W3) into the chemical structure of the copolymer used according to the invention is effected in that, for the production of the copolymer by means of a preferably radical polymerization reaction, at least one ethylenically unsaturated monomer is used, which is selected from the group consisting of alkyl (meth)acrylates, aryl (meth)acrylates, arylalkyl (meth)acrylates and alkoxyalkyl (meth)acrylates with an alkoxyalkyl residue containing 4 to 16 C atoms, and styrene.

Particularly preferably, the incorporation of the structural unit (W3) into the chemical structure of the copolymer used according to the invention is effected in that for the production of the copolymer by means of a preferably radical polymerization reaction at least one ethylenically unsaturated monomer is used, which is selected from the group consisting of alkyl (meth)acrylates, in particular selected from the group consisting of methyl (meth)acrylate, ethyl (meth)acrylate, n-butyl (meth)acrylate, i-butyl (meth)acrylate, t-butyl (meth)acrylate, lauryl (meth)acrylate, 2-ethylhexyl (meth)acrylate, stearyl (meth)acrylate, allyl (meth)acrylate, tridecyl (meth)acrylate, and benzyl (meth)acrylate.

In a particularly preferred embodiment, the homopolymer or copolymer used according to the invention is obtainable by radical copolymerization of
at least one ethylenically unsaturated monomer selected from the group consisting of vinylphosphonic acid, vinylphosphonic acid in a form at least partially esterified with a C₁₋₈ alkyl alcohol, vinylphosphoric acid in a form at least partially esterified with a C₁₋₈ alkyl alcohol, alkyl (meth)acrylates, cycloalkyl (meth)acrylates, aryl (meth)acrylates and alkylaryl (meth)acrylates, wherein the alkyl residues, cycloalkyl residues, aryl residues or alkylaryl residues of these (meth)acrylates each contain at least one functional group containing at least one phosphorus atom, for the formation of structural units (W1) within the copolymer,
and
at least one ethylenically unsaturated monomer selected from the group consisting of alkyl (meth)acrylates, cycloalkyl (meth)acrylates, aryl (meth)acrylates and alkylaryl (meth)acrylates, wherein the alkyl residues, cycloalkyl residues, aryl residues or alkylaryl residues of these (meth)acrylates each contain at least one OH group or at least one protected OH group, alkyl(meth)acrylamides, cycloalkyl(meth)acrylamides, aryl(meth)acrylamides and alkylaryl(meth)acrylamides, wherein the alkyl residues, cycloalkyl residues, aryl residues or alkylaryl residues of these (meth)acrylamides each contain at least one OH group or at least one protected OH group, allyl alcohol, vinyl alcohol and hydroxyalkyl vinyl ethers, for the formation of structural units (W2) within the copolymer
and optionally at least one ethylenically unsaturated monomer selected from the group consisting of alkyl (meth)acrylates, cycloalkyl (meth)acrylates, aryl (meth)acrylates, heteroaryl (meth)acrylates and alkylaryl (meth)acrylates, wherein the alkyl residues, cycloalkyl residues, aryl residues, heteroaryl residues or alkylaryl residues of these (meth)acrylates can optionally each contain at least one tertiary amino group and/or at least one alkoxy group, for the formation of structural units (W3) within the copolymer,
or
by radical copolymerization of at least one ethylenically unsaturated monomer selected from the group consisting of alkyl (meth)acrylates, cycloalkyl (meth)acrylates, aryl (meth)acrylates and alkylaryl (meth)acrylates, wherein the alkyl residues, cycloalkyl residues, aryl residues or alkylaryl residues of these (meth)acrylates each contain at least one OH group or at least one protected OH group, alkyl(meth)acrylamides, cycloalkyl(meth)acrylamides, aryl(meth)acrylamides and alkylaryl(meth)acrylamides, wherein the alkyl residues, cycloalkyl residues, aryl residues or alkylaryl residues of these (meth)acrylamides each contain at least one OH group or at least one protected OH group, allyl alcohol, vinyl alcohol and hydroxyalkyl vinyl ethers, for the formation of structural units (W2) within the copolymer,
and at least one ethylenically unsaturated monomer selected from the group consisting of alkyl (meth)acrylates, cycloalkyl (meth)acrylates, aryl (meth)acrylates, heteroaryl (meth)acrylates and alkylaryl (meth)acrylates, wherein the alkyl residues, cycloalkyl residues, aryl residues, heteroaryl residues or alkylaryl residues of these (meth)acrylates can optionally each contain at least one tertiary amino group and/or at least one alkoxy group, for the formation of structural units (W3) within the copolymer,
and partial phosphorylation of the hydroxyl groups contained in the structural units (W2) of the copolymer obtainable after radical copolymerization, for the formation of structural units (W1) or (W0) within the copolymer
or
by polymerization of at least one ethylenically unsaturated monomer selected from the group consisting of alkyl (meth)acrylates, cycloalkyl (meth)acrylates, aryl (meth)acrylates and alkylaryl (meth)acrylates, wherein the alkyl residues, cycloalkyl residues, aryl residues or alkylaryl residues of these (meth)acrylates each contain both at least one functional group containing at least one phosphorus atom and also at least one OH group or at least one protected OH group, for the formation of structural units (W0) within the copolymer,
and optionally at least one ethylenically unsaturated monomer selected from the group consisting of alkyl (meth)acrylates, cycloalkyl (meth)acrylates, aryl (meth)acrylates, heteroaryl (meth)acrylates and alkylaryl (meth)acrylates, wherein the alkyl residues, cycloalkyl residues, aryl residues, heteroaryl residues or alkylaryl residues of these (meth)acrylates can optionally each contain at least one tertiary amino group and/or at least one alkoxy group, for the formation of structural units (W3) within the copolymer.

In a quite especially preferred embodiment, the homopolymer or copolymer used according to the invention is obtainable by radical copolymerization of
at least one ethylenically unsaturated monomer selected from the group consisting of vinylphosphonic acid, vinylphosphonic acid in a form at least partially esterified with a C₁₋₈ alkyl alcohol, vinylphosphoric acid in a form at least partially esterified with a C₁₋₈ alkyl alcohol, 2-(meth)acryloyloxyethyl phosphate, 3-(meth)acryloyloxypropyl phosphate, 4-(meth)acryloyloxybutyl phosphate, 10-methacryloyloxydecyl dihydrogen phosphate, ethyl-2-[4-(dihydroxyphosphoryl)-2-oxabutyl]acrylate and 2,4,6-trimethylphenyl-2-[4-(dihydroxyphosphoryl)-2-oxabutyl]acrylate, for the formation of structural units (W1) within the copolymer,
and
at least one ethylenically unsaturated monomer selected from the group consisting of hydroxyethyl (meth)acrylate, hydroxypropyl (meth)acrylate and hydroxybutyl (meth)acrylate for the formation of structural units (W2) within the copolymer,
and optionally at least one ethylenically unsaturated monomer selected from the group consisting of methyl (meth)acrylate, ethyl (meth)acrylate, n-butyl (meth)acrylate, i-butyl (meth)acrylate, t-butyl (meth)acrylate, lauryl (meth)acrylate, 2-ethylhexyl (meth)acrylate, stearyl (meth)acrylate, allyl (meth)acrylate, tridecyl (meth)acrylate, and benzyl (meth)acrylate, for the formation of structural units (W3) within the copolymer,
or
by radical copolymerization of at least one ethylenically unsaturated monomer selected from the group consisting of hydroxyethyl (meth)acrylate, glycidyl (meth)acrylate, hydroxypropyl (meth)acrylate and hydroxybutyl (meth)acrylate for the formation of structural units (W2) within the copolymer,
and at least one ethylenically unsaturated monomer selected from the group consisting of methyl (meth)acrylate, ethyl (meth)acrylate, n-butyl (meth)acrylate, i-butyl (meth)acrylate, t-butyl (meth)acrylate, lauryl (meth)acrylate, 2-ethylhexyl (meth)acrylate, stearyl (meth)acrylate, allyl (meth)acrylate, tridecyl (meth)acrylate, and benzyl (meth)acrylate, for the formation of structural units (W3) within the copolymer,
and partial phosphorylation of the optionally protected hydroxyl groups contained in the structural units (W2) of the copolymer obtainable after radical copolymerization, for the formation of structural units (W1) or (W0) within the copolymer
or
by radical polymerization of at least one ethylenically unsaturated monomer selected from the group consisting of [(3-(meth)acryloyloxy-2-hydroxypropyl)]phosphate and [(2-(meth)acryloyloxy-3-hydroxypropyl)]phosphate for the formation of structural units (W0) within the homopolymer or copolymer,
and optionally at least one ethylenically unsaturated monomer selected from the group consisting of methyl (meth)acrylate, ethyl (meth)acrylate, n-butyl (meth)acrylate, i-butyl (meth)acrylate, t-butyl (meth)acrylate, lauryl (meth)acrylate, 2-ethylhexyl (meth)acrylate, stearyl (meth)acrylate, allyl (meth)acrylate, tridecyl (meth)acrylate, and benzyl (meth)acrylate, for the formation of structural units (W3) within the homopolymer or copolymer.

In a particularly preferred embodiment, the copolymer used according to the invention is obtainable by radical copolymerization of
at least one ethylenically unsaturated monomer selected from the group consisting of hydroxyethyl (meth)acrylate, glycidyl (meth)acrylate, hydroxypropyl (meth)acrylate and hydroxybutyl (meth)acrylate for the formation of structural units (W2) within the copolymer
and
at least one ethylenically unsaturated monomer selected from the group consisting of methyl (meth)acrylate, ethyl (meth)acrylate, n-butyl (meth)acrylate and 2-ethylhexyl (meth)acrylate for the formation of structural units (W3) within the copolymer,
and partial phosphorylation of the optionally protected hydroxyl groups contained in the structural units (W2) of the copolymer obtainable after radical copolymerization, for the formation of structural units (W1) or (W0) within the copolymer,

or by radical copolymerization of
at least one ethylenically unsaturated monomer selected from the group consisting of 2-(meth)acryloyloxyethyl phosphate, 3-(meth)acryloyloxypropyl phosphate and 4-(meth)acryloyloxybutyl phosphate, for the formation of structural units (W1) within the copolymer,
and
at least one ethylenically unsaturated monomer selected from the group consisting of hydroxyethyl (meth)acrylate, hydroxypropyl (meth)acrylate and hydroxybutyl (meth)acrylate for the formation of structural units (W2) within the copolymer,
and
at least one ethylenically unsaturated monomer selected from the group consisting of methyl (meth)acrylate, ethyl (meth)acrylate, n-butyl (meth)acrylate and 2-ethylhexyl (meth)acrylate for the formation of structural units (W3) within the copolymer

or by radical copolymerization of [(2-(meth)acryloyloxy-3-hydroxypropyl)]phosphate for the formation of structural units (W0) within the copolymer
and
at least one ethylenically unsaturated monomer selected from the group consisting of methyl (meth)acrylate, ethyl (meth)acrylate, n-butyl (meth)acrylate and 2-ethylhexyl (meth)acrylate for the formation of structural units (W3) within the copolymer.

Processes

The homopolymer or copolymer used according to the invention is preferably a homopolymer or copolymer which is obtainable by polymerization of preferably at least two ethylenically unsaturated compounds as monomers. As polymerization techniques for the production of the homopolymers or copolymers according to the invention, all usual polymerization techniques from the prior art and known to those skilled in the art for the polymerization of ethylenically unsaturated monomers are usable. The polymerization of such monomers here is preferably effected radically, cationically or anionically. Particularly preferable is a radical polymerization for the production of the homopolymer or copolymer used according to the invention.

For the production of the homopolymers or copolymers used according to the invention, so-called live or controlled polymerization processes can be used, for example controlled radical polymerization processes or group transfer polymerization. Examples of group transfer polymerization are found for example in O. W. Webster in “Group Transfer Polymerization”, in “Encyclopedia of Polymer Science and Engineering”, Vol. 7, H. F. Mark, N. M. Bikales, C. G. Overberger and G. Menges, Eds., Wiley Interscience, New York 1987, page 580 ff., and in O. W. Webster, Adv. Polym. Sci. 2004, 167, 1-34. Examples of controlled radical polymerization processes are atom transfer radical polymerization (ATRP), which is for example described in Chem. Rev. 2001, 101, 2921 and in Chem. Rev. 2007, 107, 2270-2299; “reversible addition fragmentation chain transfer process” (RAFT), which with use of certain polymerization regulators is also referred to as “MADIX” (macromolecular design via the interchange of xanthates) and is referred to as “addition fragmentation chain transfer” and which is for example described in Polym. Int. 2000, 49, 993, Aust. J. Chem. 2005, 58, 379, J. Polym. Sci. Part A: Polym. Chem. 2005, 43, 5347, Chem. Lett. 1993, 22, 1089, J. Polym. Sci., Part A 1989, 27, 1741 and 1991, 29, 1053 and 1993, 31, 1551 and 1994, 32, 2745 and 1996, 34, 95 and 2003, 41, 645 and 2004, 42, 597 and 2004, 42, 6021 and also in Macromol. Rapid Commun. 2003, 24, 197, in Polymer 2005, 46, 8458-8468 and Polymer 2008, 49, 1079-1131 and in U.S. Pat. No. 6,291,620, WO 98/01478, WO 98/58974 and W0 99/31144; controlled polymerization with nitroxyl compounds as polymerization regulators (NMP), as for example disclosed in Chem. Rev. 2001, 101, 3661; controlled radical polymerization with tetraphenylethane, as for example described in Macromol. Symp. 1996, 111, 63; controlled radical polymerization with 1,1-diphenylethene as polymerization regulator, as for example described in Macromolecular Rapid Communications, 2001, 22, 700; controlled radical polymerization with organotellurium, organoantimony and organobismuth chain transfer agents, as described in Chem. Rev. 2009, 109, 5051-5068; controlled radical polymerization with iniferters for example disclosed in Makromol. Chem. Rapid. Commun. 1982, 3, 127; controlled radical polymerization with organocobalt complexes, as for example known from J. Am. Chem. Soc. 1994, 116, 7973, from Journal of Polymer Science: Part A: Polymer Chemistry, Vol. 38, 1753-1766 (2000), from Chem. Rev. 2001, 101, 3611-3659 and from Macromolecules 2006, 39, 8219-8222; reversible chain transfer catalyzed polymerization, as disclosed in Polymer 2008, 49, 5177; degenerative chain transfer with iodine compounds, as for example described in Macromolecules 2008, 41, 6261 and in Chem. Rev. 2006, 106, 3936-3962 or in U.S. Pat. No. 7,034,085; controlled radical polymerization in presence of thioketones is for example described in Chem. Commun., 2006, 835-837 and in Macromol. Rapid Commun. 2007, 28, 746-753.

Preferably the polymerization takes place in a suitable organic solvent. Particularly preferable solvents are esters such as 1-methoxy-2-propyl acetate and/or n-butyl acetate, and/or aromatic solvents such as toluene, xylene, ethylbenzene and/or trimethylbenzene.

Adhesion Strengthening

The homopolymer or copolymer used according to the invention is suitable as an adhesion-strengthening additive. One subject of the present invention is therefore the use of the homopolymer or copolymer used according to the invention as an adhesion promoter or adhesion-strengthening additive.

Preferably, the use according to the invention takes place in a manner such that the homopolymer or copolymer is used as an adhesion-strengthening additive for adhesion promotion between a substrate optionally coated with at least one layer and at least one layer to be applied onto the substrate optionally coated with at least one layer.

Particularly preferably, the use of the homopolymer or copolymer as an adhesion-strengthening additive takes place in such a manner that the homopolymer or copolymer is used as an adhesion promoter or as an adhesion-strengthening additive between two layers of a substrate coated with at least these two layers. Here the homopolymer or copolymer is used as an adhesion promoter or adhesion-strengthening additive between a substrate coated with at least one layer and at least one further layer to be applied onto the coated substrate, such as for example as an adhesion promoter between a base lacquer layer present on a substrate and a clear lacquer layer to be applied over this. Here the homopolymer or copolymer used according to the invention is preferably contained in the coating composition which serves for the application of the further layer such as for example the clear lacquer layer onto the coated substrate. Here the at least two superimposed layers present on the substrate after the coating are either the same or different, preferably different, from one another. Preferably, the at least two superimposed layers are, each mutually independently, based on at least one synthetic, semisynthetic and/or natural polymer, which is preferably used as a binder within the particular layer.

Preferably, the homopolymer or copolymer as an adhesion-strengthening additive is present as a component of a coating composition, i.e. the use according to the invention preferably takes place here such that the homopolymer or copolymer is a component of a coating composition.

Particularly preferable is a use in which the homopolymer or copolymer is used as an adhesion-strengthening additive as a component of a coating composition for the application of a preferably outer layer onto a substrate coated with at least one layer, in particular onto a layer provided with a multilayer structure such as for example a multilayer lacquer structure. A further lacquer layer such as a clear lacquer layer can optionally be applied onto the coating composition applied onto the substrate and the homopolymer or copolymer used according to the invention contained as a component as an adhesion-strengthening additive, in particular when the coating composition containing the homopolymer or copolymer used according to the invention as an adhesion-strengthening additive is used for the application of a repair lacquer layer or maintenance lacquer layer.

The homopolymer or copolymer can be a component of the at least one further layer to be applied onto the coated substrate, such as for example a component of a clear lacquer layer which is applied onto a substrate coated with at least one base lacquer layer. In this case, adhesion promotion takes place between the base lacquer layer and the clear lacquer layer on the basis of the adhesion-promoting action of the copolymer contained in the clear lacquer layer to be applied. Alternatively, the homopolymer or copolymer used according to the invention can be a component of a coating composition which is used in the form of an adhesion promoter layer between the substrate coated with at least one layer and the further layer to be applied thereon.

Alternatively, the use of the homopolymer or copolymer as an adhesion-strengthening additive takes place in such a manner that the homopolymer or copolymer is used as an adhesion promoter between at least one layer to be applied onto a substrate and the substrate itself. In this case also, the use according to the invention here preferably takes place such that the homopolymer or copolymer is a component of a coating composition, wherein the homopolymer or copolymer can either be a component of a coating composition which is a applied in the form of an adhesion promoter layer between substrate and the layer to be applied or is a component of a coating composition which is used for the production of the layer to be applied onto the substrate.

Surprisingly, through the use of the homopolymer or copolymer used according to the invention as an adhesion-strengthening additive, in particular as a component of a coating composition containing such an adhesion-strengthening additive, it is possible markedly to improve the adhesion between the uncoated substrate and a coating to be applied thereon (primer adhesion) or between at least one coating present on a substrate and a coating to be applied thereon (Interlayer adhesion), in particular each independently based on at least one synthetic, semisynthetic and/or natural polymer, and thereby decisively to prevent damaging influences such as for example weathering or visible blemishes.

The coating of the substrate can preferably be effected according to all application methods known from the prior art, such as for example painting, spray-coating, spraying, rolling, doctor blade coating or dipping. The coating of the substrate preferably comprises a single-sided coating of the substrate. In principle however, the substrate used can also be coated on both sides, wherein in the case of two-sided coating the respective coatings do not have to be identical. For example, one side of a substrate can be coated with one layer, and the other side of the substrate have another coating.

As the substrate to be used according to the invention, a substrate selected from the group consisting of the materials metal, glass, ceramic, wood and plastic, wherein the substrate can in each case already have at least one coating such as for example a lacquering, is preferably suitable. The substrate surface to be coated can be flat or non-flat, such as for example bent, curved, corrugated, kinked or otherwise non-uniformly shaped. Thus for example the surface of a wire is also a flat surface of a body in the sense of the invention and hence a substrate.

Preferably, as stated above, the use of the homopolymer or copolymer used according to the invention as an adhesion-strengthening additive takes place in such a manner that the homopolymer or copolymer is used as an adhesion-strengthening additive between two layers of a substrate coated with at least two superimposed layers, such as for example as an adhesion promoter between a base lacquer layer present on a substrate and a clear lacquer layer present above this. Here, the at least two superimposed layers can be applied successively onto the substrate: thus for example, a base lacquer layer can firstly be applied onto the substrate and then a clear lacquer layer, which preferably contains the homopolymer or copolymer used according to the invention. If the homopolymer or copolymer is used as a component of an adhesion promoter layer, then this can be applied after application of the base lacquer layer, and then subsequently the clear lacquer layer. Here the base lacquer layer can firstly be completely hardened before application of the further layer(s) or alternatively be hardened only incompletely or not at all before application of the further layer(s). In the latter case, a simultaneous hardening of all layers takes place, after they have been applied.

In coating structures comprising two or more layers, these layers can be applied directly consecutively (as typical in a multilayer lacquer structure) or else there can be a longer time interval between the lacquering of one layer and the overlacquering with the next layer (e.g. in repair work or maintenance work, which are only applied when needed to remediate damage); here, a repair lacquering can itself also again have a multilayer structure, i.e. consist of more than one lacquer layer, wherein the homopolymer or copolymer according to the invention can be used as an adhesion promoter between these lacquer layers.

Coating Composition

A further subject of the present invention is a coating composition comprising at least one homopolymer or copolymer used according to the invention as an adhesion-strengthening additive as component (A). Preferably, the coating composition according to the invention additionally contains at least one binder (B).

A further subject of the present invention is a coating composition comprising
(A) at least one homopolymer or copolymer used according to the invention as an adhesive-strengthening additive in a quantity in a range from 0.1 to 15 wt. %, based on the total weight of the coating composition, and
(B) at least one binder in a quantity in a range from 20 to 99 wt. %, based on the total weight of the coating composition, in particular at least one binder (B) selected from the group consisting of polyurethanes and polyureas and mixtures thereof.

Thus for example a further subject of the present invention is a coating composition comprising
(A) at least one homopolymer or copolymer obtainable by polymerization of ethylenically unsaturated monomers as an adhesion-strengthening additive, which is composed of at least one structural unit (W0) and optionally at least one further structural unit (W3) different from (W0),
   wherein
   each structural unit (W0) both contains at least one functional group which contains at least one phosphorus atom, and also contains at least one functional group reactive towards an isocyanate group,
   and the homopolymer or copolymer, based on the total quantity of the at least one structural unit (W0) and optionally (W3) within the polymer main chain of the homopolymer or copolymer, contains the following proportions in mol. %:
      1 to 100 mol. % of the structural units (W0) and
      0 to 99 mol. % of the structural units (W3),
   or which is composed of at least two structural units (W1) and (W2) different from one another and optionally at least one further structural unit (W3) different from (W1) and (W2),
   wherein
   each structural unit (W1) contains at least one functional group which contains at least one phosphorus atom, and optionally at least one part of the structural units (W1) additionally contains at least one functional
   each structural unit (W2) contains at least one functional group reactive towards an isocyanate group, wherein none of the structural units (W2) contains phosphorus atoms,
   and the homopolymer or copolymer, based on the total quantity of the at least two structural units (W1) and (W2) and optionally (W3) within the polymer main chain of the homopolymer or copolymer, contains the following proportions in mol. %:
      1 to 80 mol. % of the structural units (W1),
      1 to 80 mol. % of the structural units (W2) and
      0 to 98 mol. % of the structural units (W3),
   in a quantity in a range from 0.1 to 15 wt. %, based on the total weight of the coating composition, and
(B) at least one binder in a quantity in a range from 20 to 99 wt. %, based on the total weight of the coating composition.

All preferred embodiments described above herein in connection with the use of the homopolymer or copolymer used according to the invention as an adhesion-strengthening additive or adhesion promoter are also preferred embodiments of the homopolymer or copolymer used according to the invention as component (A) of the coating composition according to the invention.

In the sense of the present invention, such as for example in connection with the coating composition according to the invention, the term “comprising” has in a preferred embodiment the meaning “consisting of”. Also, as regards the coating composition according to the invention in this preferred embodiment, one or more of the further components mentioned below optionally contained in the coating composition according to the invention can be contained in the coating composition. All components here can each in their above- and below-mentioned preferred embodiments be contained in the coating composition according to the invention.

Preferably the quantities in wt. % of all components and additives contained in the coating composition according to the invention make up a total of 100 wt. %, based on the total weight of the coating composition.

The coating composition according to the invention can be applied onto all usual substrates, in particular onto the aforementioned substrates. As a particularly preferable substrate, an already coated substrate is suitable, i.e. a substrate coated in total at least with two preferably superimposed layers is obtained by application of the coating composition according to the invention. Here, the substrate can preferably already be coated with a coating such as a lacquer, preferably a coating based on a polyurethane, polyester, polyamide, polyurea, polyvinyl chloride, polystyrene, polycarbonate, poly(meth)acrylate, epoxy resin, phenol-formaldehyde resin, melamine-formaldehyde resin, phenol resin, and/or silicone resins, particularly preferably with a coating based on at least one poly(meth)acrylate, in particular on at least one polyacrylate. For the production of the layer already present on the substrate before application of the coating composition according to the invention, an aqueous acrylate dispersion is particularly preferably used. Preferably, the layer already present on the substrate before application of the coating composition according to the invention is a base lacquer layer.

Preferably, the coating composition according to the invention is a coating composition for the production of a clear lacquer layer, a repair lacquer layer or a production line lacquer, particularly preferably for the production of a clear lacquer layer or a repair lacquer layer.

After application of the coating composition according to the invention onto a coated substrate, this can be one of the at least two superimposed layers of the substrate then coated with at least two superimposed layers. In this case, adhesion promotion takes place between the layer applied by use of the coating composition and the layer already present on the substrate on the basis of the adhesion-promoting action of the homopolymer or copolymer contained in the coating composition. Alternatively the homopolymer or copolymer used according to the invention can be a component of a coating composition which is applied onto an uncoated substrate.

Alternatively, the homopolymer or copolymer used according to the invention can be a component of a coating composition which is used in the form of an adhesion promoter layer between at least two superimposed layers of a substrate coated with at least two superimposed layers. In this case, the coating composition according to the invention can be used as a coating composition for the production of an adhesion promoter layer. Preferably, in this case the coating composition contains at least one wetting agent and/or flow control agent.

All usual binders (B) known to those skilled in the art are suitable as binder components of the coating composition according to the invention. As the binder contained in the coating composition according to the invention, at least one binder based on at least one synthetic, semisynthetic or natural polymer or a mixture of at least two of these polymers are preferably suitable.

The binder (B) can be present dissolved or dispersed in a diluent such as at least one organic solvent and/or water, preferably in at least one organic solvent.

The binder (B) used according to the invention preferably has crosslinkable functional groups. Here, any usual crosslinkable functional group known to those skilled in the art is possible. In particular, the crosslinkable functional groups are selected from the group consisting of hydroxyl groups, amino groups, carboxylic acid groups, unsaturated carbon double bonds, isocyanates, polyisocyanates and epoxides. Particularly preferable are isocyanates and polyisocyanates. The binder is preferably exothermically or endothermically crosslinkable or hardenable. Preferably, the binder is crosslinkable or hardenable in a temperature range from −20° C. up to 250° C., preferably from 18° C. to 200° C.

Preferably, at least one polymer selected from the group consisting of polyurethanes, polyesters, polyamides, polyureas, polyvinyl chlorides, polystyrenes, polycarbonates, poly(meth)acrylates, epoxy resins, phenol-formaldehyde resins, melamine-formaldehyde resins, phenol resins and silicone resins can be used as binder (B), wherein preferably 70 to 100 wt. % of the binder (B) contained in the coating composition are selected from at least one of the aforementioned polymers.

Particularly preferably, the binder (B) is selected from the group consisting of polyurethanes and polyureas, wherein preferably 70 to 100 wt. % of the binder (B) contained in the coating compositions are selected from at least one of the aforementioned polymers.

In another preferred embodiment, at least one polymer selected from the group consisting of polyurethanes, polyesters, polyamides, polyureas, polyvinyl chlorides, polystyrenes, polycarbonates, poly(meth)acrylates, epoxy resins, phenol-formaldehyde resins, melamine-formaldehyde resins, phenol resins and silicone resins, in particular selected from the group consisting of polyureas and polyurethanes, can be used as binder (B), wherein the binder in this case is preferably present in a quantity from 25 to 95 wt. %, quite especially preferably in a quantity from 30 to 90 wt. %, and particularly preferably in a quantity from 40 to 80 wt. %, based on the total weight of the coating composition. Quite especially preferably, at least one polyurethane is used as binder (B) and in particular the coating composition according to the invention in this case preferably contains the binder in a quantity from 25 to 95 wt. %, quite especially preferably in a quantity from 30 to 90 wt. %, particularly preferably in a quantity from 40 to 80 wt. %, based on the total weight of the coating composition.

Particularly preferably, as binder (B), a binder which is hardened with participation of isocyanate and/or oligomerized isocyanate groups, quite especially preferably at least one corresponding polyurethane and/or at least one corresponding polyurea (e.g. so-called “polyaspartic binders”) can be used. Polyaspartic binders are compounds, which are converted from reaction of amino-functional compounds, in particular secondary amines, with isocyanates.

If at least one polyurethane is used as binder (B), then in particular polyurethane-based resins, which are prepared by a polyaddition reaction between hydroxyl group-containing compounds such as polyols (such as for example hydroxyl group of hydroxyl group-containing polyesters or hydroxyl group-containing polyethers and mixtures and copolymers thereof) and at least one polyisocyanate (aromatic and aliphatic isocyanates, di-, tri- and/or polyisocyanates) are suitable as such a binder.

Here, a stoichiometric reaction of the OH of the polyols with the NCO groups of the polyisocyanates is usually necessary. However, the stoichiometric ratio to be used can also be varied, since the polyisocyanate can be added to the polyol component in quantities such that an “overcrosslinking” or an “undercrosslinking” can occur. As a further reaction for the crosslinking, as well as a reaction of NCO groups with OH groups (in the case of polyurethane binders) or amino groups (in the case of polyurea binders), for example di- and trimerization of isocyanates (to uretdiones or isocyanurates) can also occur.

If epoxy resins, i.e. epoxide-based resins are used as binder (B), then those epoxide-based resins, which are produced from glycidyl ethers, which have terminal epoxide groups and hydroxyl groups as functional groups within the molecule are preferably suitable. Preferably, these are reaction products of bisphenol A and epichlorohydrin or bisphenol F with epichlorohydrin and mixtures thereof, which are also used in presence of so-called reactive diluents (i.e. low molecular weight epoxide functional compounds such as for example alkyl- or arylglycide ethers). The hardening or crosslinking of such epoxide-based resins usually takes place by polymerization of the epoxide groups of the epoxide ring, by a polyaddition reaction in the form of addition of other reactive compounds as hardening agents in stoichiometric quantities to the epoxide groups, wherein accordingly the presence of one active hydrogen equivalent per epoxide group is necessary (i.e. one H-active equivalent per epoxide equivalent is needed for the hardening), or by a polycondensation via the epoxide and the hydroxyl groups. Suitable hardeners are for example polyamines, in particular (hetero)aliphatic, (hetero)aromatic and (hetero) cycloaliphatic polyamines, polyamidoamines, polyaminoamides and polycarboxylic acids and anhydrides thereof.

Preferably, the coating composition according to the invention contains the binder in a quantity from 20 to 99 wt. %, particularly preferably in a quantity from 25 to 95 wt. %, quite especially preferably in a quantity from 30 to 90 wt. %, particularly preferably in a quantity from 40 to 80 wt. %, based on the total weight of the coating composition.

Preferably, the binder used according to the invention has a non-volatile content, i.e. a solids content, from 30 to 90 wt. %, particularly preferably from 40 to 85 wt. %, quite especially preferably from 50 to 80 wt. %, each based on the total weight of the binder. The determination of the solids content is performed by the method described below.

Preferably, the coating composition according to the invention has a non-volatile content, i.e. a solids content, from 10 to 90 wt. %, particularly preferably from 15 to 85 wt. %, quite especially preferably from 25 to 80 wt. %, particularly preferably from 30 to 80 wt. %, most preferably from 40 to 80 wt. %, each based on the total weight of the coating composition. The determination of the solids content is performed by the method described below.

The coating composition according to the invention can optionally include at least one hardening agent, which is preferably suitable for crosslinking. Such hardening agents are known to those skilled in the art. To accelerate the crosslinking, suitable catalysts can be added to the coating composition. All usual hardening agents known to those skilled in the art can be used for the production of the coating composition according to the invention.

If at least one polyurethane is used as binder, then the at least one isocyanate compound used for the production of the polyurethane is preferably described as a hardening agent.

Preferably the coating composition according to the invention contains the hardening agent in a quantity from 2 to 100 wt. %, preferably in a quantity from 2 to 80 wt. %, particularly preferably in a quantity from 2 to 50 wt. %, each based on the total weight of the binder.

Preferably, the coating composition according to the invention contains the catalyst in a quantity from 0.001 to 20 wt. %, particularly preferably in a quantity from 0.002 to 15 wt. %, quite especially preferably in a quantity from 0.004 to 10 wt. %, in particular in a quantity from 0.006 to 5 wt. % or in a quantity from 0.010 to 3 wt. %, each based on the total weight of the coating composition.

Preferably, the homopolymer or copolymer used according to the invention is contained in the coating composition according to the invention in a quantity in a range from 0.1 to 15 wt. % or in a range from 0.2 to 12 wt. %, particularly preferably in a range from 0.3 to 10 wt. %, quite especially preferably in a range from 0.4 to 8 wt. %, particularly preferably in a range from 0.5 to 6 wt. %, most preferably in a range from 0.6 to 5 wt. % or from 0.7 to 4 wt. % or from 0.8 to 3 wt. %, each based on the total weight of the coating composition.

In another preferred embodiment, the homopolymer or copolymer used according to the invention is contained in the coating composition according to the invention in a quantity in a range of ≦10 wt. % or in a range of ≦9 wt. %, particularly preferably in a range of ≦8 wt. %, quite especially preferably in a range of ≦7 wt. %, particularly preferably in a range of ≦6 wt. %, most preferably in a range of ≦5 wt. % or of ≦4 wt. % or of ≦3 wt. %, each based on the total weight of the coating composition.

Depending on the desired use purpose, which can be decorative and/or technical, the coating composition according to the invention can contain one or more normally used further additives. Preferably, these additives are selected from the group consisting of antioxidants, antistatic agents, emulsifiers, flow control agents, solubilizers, defoaming agents, crosslinking agents, stabilizers, preferably heat- and/or warmth stabilizers, process stabilizers and UV- and/or light stabilizers, deaerating agents, inhibitors, catalysts, waxes, wetting and dispersing agents, flexibilization agents, flame retardants, solvents, reactive diluents, carrier media, resins, hydrophobization agents, hydrophilization agents, carbon black, metal oxides and/or metalloid oxides, thickeners, thixotropic agents, impact modifiers, blowing agents, processing aids, plasticizers, powdery and fibrous solids, preferably powdery and fibrous solids selected from the group consisting of fillers, glass fibers, reinforcers and pigments, and mixtures of the above-mentioned further additives. Depending on the use purpose, the additive content in the coating composition according to the invention can vary very widely. Preferably, the content, based on the total weight of the coating composition according to the invention is 0.01 to 15.0 wt. %, still more preferably 0.05 to 10.0 wt. %, particularly preferably 0.1 to 8.0 wt. %, quite especially preferably 0.1 to 6.0 wt. %, in particular 0.1 to 4.0 wt. % and most preferably 0.1 to 3.0 wt. %.

Furthermore, the coating compositions can be printed or embossed, preferably in the hardened state.

The present invention further relates to a process for the production of the coating composition according to the invention. The coating composition according to the invention can be produced by mixing and dispersing and/or dissolving the respective components of the coating composition, which have been described above, for example by means of automated metering and mixing units, high speed stirrers, stirring vessels, stirring mills, dissolvers, kneaders or in-line dissolvers.

Use of the Coating Composition

The coating composition according to the invention is suitable in particular as clear lacquer, production line lacquer, repair lacquer and/or maintenance lacquer.

A further subject of the present invention is therefore use of the coating composition according to the invention as clear lacquer, production line lacquer, repair lacquer or maintenance lacquer.

For this, the coating composition according to the invention is preferably at least partially, i.e. selectively or completely, applied onto the surface to be coated of a preferably already coated substrate, particularly preferably already coated at least with a base lacquer layer.

Coated Substrate

A further subject of the invention is a process for the production of a substrate at least partially coated with the coating composition according to the invention. In this, preferably a coating composition according to the invention, preferably a coating composition for the production of an adhesion promoter layer or a clear lacquer layer or repair lacquer layer or a maintenance lacquer layer, in particular a clear lacquer layer, is applied onto a substrate, in particular onto a substrate already coated with at least one coating such as a lacquer layer, preferably a base lacquer layer, and then physically dried, stoved and/or hardened or crosslinked. If the coating composition according to the invention is used as a coating composition for the production of an adhesion promoter layer, then after the application of this a clear lacquer layer can be applied. Here, the adhesion promoter layer can firstly be completely hardened before application of the further clear lacquer layer or alternatively be hardened only incompletely or not at all before application of the further clear lacquer layer. In the latter case, simultaneous hardening of all layers is effected, after they have been applied.

A further subject of the invention is a substrate at least partially coated with the coating composition according to the invention, which is preferably obtainable by the aforementioned process.

Determination Methods

1. Determination of the Adhesion Properties Between a Base Lacquer Layer Applied on a Substrate and a Clear Lacquer Layer Applied on this Base Lacquer Layer

An E-coated metal plate from Krüppel (size 10 cm×20 cm) used as substrate is pretreated by means of abrasive paper (from 3M, Scotch-Brite) and cleaned by washing with ethyl acetate. A base lacquer such as for example a base lacquer M3 used according to the invention is applied onto such an E-coated plate by spray application with an HVLP (high volume low pressure) pistol and dried at a temperature in the range from 18 to 23° C. over a period of 30 minutes. Directly afterwards, a clear lacquer such as for example a clear lacquer obtained by incorporation of a hardener solution according to table 2 and a diluent solution according to table 3 into one of the mixtures M1B1, M1B3, M1B4, M1B5, M1B6, M1B7, M1B8 and M1V1 is applied by spray application with an HVLP pistol onto the E-coated plate coated with the base lacquer and dried over a period of 10 minutes at a temperature in the range from 18 to 23° C. and then in an oven over a period of 30 minutes at a temperature of 60° C. The coated plate thus obtained is stored over a period of 5 days at a temperature in the range from 18 to 23° C. and then in an oven over a period of 5 days at a temperature of 70° C. After removal from the oven, the plate is allowed to cool for 30 minutes.

Next, a diagonal cross (arm length: 10 cm, angle 30°) is scratched into the coated plate down to the substrate with a Sikkens scratching tool (model: Erichsen 463, 1 mm blade width). Directly afterwards, a steam jet test is performed. This is performed by means of a Walter LTA 1-H-A-L-P Steam Jet Tester at a water temperature of 60° C., an angle of 30°, and a water pressure of 60 bar over a period of 1 minute and a distance of 10 cm from the coated substrate. During this, such a steam jet is directed from the appropriate distance onto the scratch region of the coated substrate.

The adhesive properties are assessed by measuring with a ruler the width in [mm] of a delamination caused by the steam jet treatment along the scratch. This is illustrated in FIG. 1: in this, the symbols 1 to 4 have the following meanings:
1: coated E-coated plate
2: scratched-in diagonal cross
3: width in [mm] of the delamination along the scratch caused by the steam jet treatment
4: delaminated area

For the case of irregular detachment, in each case the maximal width of the detachment in [mm] is determined, which corresponds to symbol 3 in FIG. 1.

2. Determination of the Non-Volatile Fractions

The determination of the non-volatile fractions, i.e. of the solids content is effected according to DIN EN ISO 3251 at a temperature of 150° C. over a period of 20 minutes.

3. Determination of the Number Average Molecular Weight

The determination of the number average molecular weight (Mₙ) is effected by gel permeation chromatography (GPC). The determination method here is conducted according to DIN 55672-1. As well as the number average molecular weight, the weight average molecular weight (M_{w}) and the polydispersity (ratio of weight average molecular weight (M_{w}) to number average molecular weight (Mₙ)) can also be determined with this method.

100±50 mg of a sample (based on the solids content of the sample) are weighed out with an analytical balance and dissolved in 10 mL±1 mL of mobile phase, during which care must be taken that the concentration limits stated in DIN 55672-1 are not exceeded nor fallen below. As the mobile phase, tetrahydrofuran (analytical quality, filtered through a 0.45 μm membrane filter) which contains 500 mg/L±50 mg/L of flowers of sulfur is used. 2-3 mL of the sample are filtered through a 0.45 μm disposable filter into an autosampler vial and this is sealed. A double determination of each sample is performed.

The determination of the number average molecular weight (Mₙ) is performed against linearly built up, narrow distribution polystyrene standards of different molecular weights Mₚ in the range from 162 to 1,000,000 g/mol. Also, before the start of each single determination, a calibration is performed against these polystyrene standards. For this, the polystyrene standards are weighed out in a quantity from 10±2 mg with an analytical balance and dissolved in 20 mL±1 mL of mobile phase. As the mobile phase, tetrahydrofuran (analytical quality, filtered through a 0.45 μm membrane filter) which contains 500 mg/L±50 mg/L of flowers of sulfur is used. The finished standard solutions are filtered through a 0.45 μm disposable filter. Several standards are combined into a mixture and chromatographed. A calibration curve (3^{rd} order regression) is constructed from the calibration points (retention times and molecular weights Mₚ) of the standards.

As the apparatus, a system with the following components is used:
HPLC pump WATERS 600 or separation module Waters 2695, each from Waters
Online degasser ERC Series 300, DEGASYS DG-1310, Degassex DG 4400 or separation module Waters 2695,
automatic sampler WATERS 717 or separation module Waters 2695
Differential refractometer WATERS 410, WATERS 2410 or WATERS 2414,
UV/VIS detector WATERS 2487, Waters 486 or WATERS 2996
Software WATERS Empower,
Combination of three GPC separating columns (Styragel columns from Waters) with a size of 300 mm•7.8 mm ID/column with a particle size of 5 μm and a pore size HR4, HR2 or HR1.

The following settings were used for this:
Injection volume: 100 μl-200 μl
Flow rate (throughput): 1 ml/min
Run time: 45 min
Refractometer setting: Sensitivity: 32 (SENS 32), Polarity+(positive) and temperature: 40° C. (each for WATERS 410, WATERS 2410 or WATERS 2414)

The assessment, in particular the determination of Mₙ, is performed with software support with the WATERS Empower software. Baseline points and assessment limits are defined according to DIN 55672-1.

The following examples and comparative examples serve for the illustration of the invention, but should not be regarded as limiting.

Unless otherwise stated, percentage data are in each case weight percent.

### EXAMPLES AND COMPARATIVE EXAMPLES

### 1. Production of Copolymers Used According to the Invention

The production of the copolymers used according to the invention can optionally be effected with addition of at least one organic solvent such as for example 1-methoxy-2-propyl acetate, n-butyl acetate, toluene and/or xylene.

The conversion of the respective polymerization reactions performed for the production of the copolymers used according to the invention can be tested by means of NMR spectroscopy: in all cases, the conditions of the polymerization were selected such that the conversion of all ethylenically unsaturated monomers used was at least 99.8%.

The abbreviations used below have the following meanings:
PMA: 1-methoxy-2-propyl acetate
AMBN: 2,2′-azobis[2-methylbutyronitrile]

### Example B1

### Stage 1

200 g of 1-methoxy-2-propyl acetate are placed in a three-necked flask with stirrer, reflux condenser and gas inlet under a current of nitrogen and heated to 130° C. A mixture of 130.24 g of methyl methacrylate, 38.12 g of hydroxyethyl methacrylate and 18.96 g of AMBN is metered in at this temperature at a feed rate of 0.6 mL/min. It is then stirred for ca. 60 mins at 130° C. After this, a post-initiation is performed with 6 g of AMBN. The mixture is stirred for a further hour at 130° C. A further post-initiation is performed with 4 g of AMBN. The mixture is stirred for a further hour at 130° C. A further post-initiation is performed with 4 g of AMBN. The mixture is stirred for a further hour at 130° C. Product obtained: non-volatile fractions: 49.8%.

Stage 2:

50.0 g of stage 1 and 4.55 g of 1-methoxy-2-propyl acetate are weighed into a three-necked flask with stirrer, reflux condenser and gas inlet under a current of nitrogen and this is heated to 80° C. Next, 4.75 g of polyphosphoric acid are metered in within ca. 10 mins. The mixture is allowed to react for a further 4 hrs at 80° C. Product obtained: non-volatile fractions: 50.4%.

### Example B2

### Stage 1

200 g of 1-methoxy-2-propyl acetate and 10.9 g of laurylmercaptan are placed in a three-necked flask with stirrer, reflux condenser and gas inlet under a current of nitrogen and heated to 130° C. A mixture of 130.24 g of methyl methacrylate 38.12 g of hydroxyethyl methacrylate and 12.64 g of AMBN is metered in at this temperature at a feed rate of 0.6 mL/min. The mixture is further stirred for ca. 60 min at 130° C. After this, a post-initiation is performed with 4 g of AMBN. The mixture is stirred for a further hour at 130° C. A further post-initiation is performed with 4 g of AMBN. The mixture is stirred for a further hour at 130° C. A further post-initiation is performed with 4 g of AMBN. The mixture is stirred for a further hour at 130° C. Product obtained: non-volatile fractions: 49.6%.

Stage 2:

50.0 g of stage 1 and 4.55 g of 1-methoxy-2-propyl acetate are weighed into a three-necked flask with stirrer, reflux condenser and gas inlet under a current of nitrogen and this is heated to 80° C. Next, 4.75 g of polyphosphoric acid are fed in within ca. 10 mins. The mixture is allowed to react for a further 4 hrs at 80° C. Product obtained: non-volatile fractions: 50.2%.

### Example B3

### Stage 1

200 g of 1-methoxy-2-propyl acetate are placed in a three-necked flask with stirrer, reflux condenser and gas inlet under a current of nitrogen and heated to 130° C. A mixture of 118.88 g of methyl methacrylate, 52.20 g of hydroxyethyl methacrylate and 17.28 g of AMBN is metered in at this temperature at a feed rate of 0.6 mL/min. The mixture is stirred for ca. 60 mins more at 130° C. After this, a post-initiation is performed with 6 g of AMBN. The mixture is stirred for a further hour at 130° C. A further post-initiation is performed with 4 g of AMBN. The mixture is stirred for a further hour at 130° C. A further post-initiation is performed with 4 g of AMBN. The mixture is stirred for a further hour at 130° C. Product obtained: non-volatile fractions: 49.0%.

Stage 2:

50.0 g of stage 1 and 3.21 g of 1-methoxy-2-propyl acetate are weighed into a three-necked flask with stirrer, reflux condenser and gas inlet under a current of nitrogen and this is heated to 80° C. Next, 3.79 g of polyphosphoric acid are metered in within ca 10 mins. The mixture is allowed to react for a further 4 hrs at 80° C. Product obtained: non-volatile fractions: 50.4%.

### Example B4

### Stage 1

149.92 g xylene are placed in a three-necked flask with stirrer, reflux condenser and gas inlet under a current of nitrogen and heated to 130° C. A mixture of 156.4 g of n-butyl acrylate, 45.88 g of hydroxyethyl methacrylate and 17.16 g of AMBN is metered in at this temperature at a feed rate of 0.60 mL/min. The mixture is stirred for ca. 60 mins more at 130° C. After this, a post-initiation is performed with 3.36 g of AMBN. The mixture is stirred for a further hour at 130° C. A further post-initiation is performed with 3.36 g of AMBN. The mixture is stirred for a further hour at 130° C. A further post-initiation is performed with 3.36 g of AMBN. The mixture is stirred for a further hour at 130° C. Product obtained: non-volatile fractions: 65.5%.

Stage 2:

50.0 g of stage 1 and 6.67 g xylene are weighed into a three-necked flask with stirrer, reflux condenser and gas inlet under a current of nitrogen and this is heated to 80° C. Next, 3.13 g of polyphosphoric acid is metered in within ca 10 mins. The mixture is allowed to react for a further 4 hrs at 80° C. Product obtained: non-volatile fractions: 62.1%.

### Example B5

### Stage 1

142.6 g xylene are placed in a three-necked flask with stirrer, reflux condenser and gas inlet under a current of nitrogen and heated to 130° C. A mixture of 181.68 g of 2-ethylhexyl acrylate, 37.12 g of hydroxyethyl methacrylate and 13.86 g of AMBN is metered in at this temperature at a feed rate of 0.6 mL/min. The mixture is stirred for ca. 60 mins more at 130° C. After this, a post-initiation is performed of 2.71 g of AMBN. The mixture is stirred for a further hour at 130° C. A further post-initiation is performed with 2.71 g of AMBN. The mixture is stirred for a further hour at 130° C. A further post-initiation is performed with 2.71 g of AMBN. The mixture is stirred for a further hour at 130° C. Product obtained: non-volatile fractions: 65.9%.

Stage 2:

50.0 g of stage 1 and 6.61 g xylene are weighed into a three-necked flask with stirrer, reflux condenser and gas inlet under a current of nitrogen and this is heated to 80° C. Next, 2.54 g of polyphosphoric acid are metered in within ca. 10 mins. The mixture is allowed to react for a further 4 hrs at 80° C. Product obtained: non-volatile fractions: 66.5%.

### Example B6

### Stage 1

138.76 g xylene are placed in a three-necked flask with stirrer, reflux condenser and gas inlet under a current of nitrogen and heated to 130° C. A mixture of 115.76 g of n-butyl acrylate, 53.04 g of benzyl acrylate, 45.28 g of hydroxyethyl methacrylate and 16.92 g of AMBN is metered in at this temperature at a feed rate of 0.6 mL/min. This is stirred for ca. 60 mins more at 130° C. After this, a post-initiation is performed with 3.31 g of AMBN. The mixture is stirred for a further hour at 130° C. A further post-initiation is performed with 3.31 g of AMBN. The mixture is stirred for a further hour at 130° C. A further post-initiation is performed with 3.31 g of AMBN. The mixture is stirred for a further hour at 130° C. Product obtained: non-volatile fractions: 65.7%.

Stage 2:

50.0 g of stage 1 and 6.73 g xylene are weighed into a three-necked flask with stirrer, reflux condenser and gas inlet under a current of nitrogen and this is heated to 80° C. Next, 2.97 g of polyphosphoric acid is metered in within ca. 10 mins. The mixture is allowed to react for a further 4 hrs at 80° C. Product obtained: non-volatile fractions: 69.5%.

### Example B7

### Stage 1

140.48 g xylene are placed in a three-necked flask with stirrer, reflux condenser and gas inlet under a current of nitrogen and heated to 130° C. A mixture of 106.40 g n-butyl acrylate, 68.16 g ethyl triglycol methacrylate, 41.60 g of hydroxyethyl methacrylate and 15.54 g of AMBN is metered in at this temperature at a feed rate of 0.6 mL/min. The mixture is stirred for ca. 60 mins more at 130° C. After this, a post-initiation is performed with 3.04 g of AMBN. The mixture is stirred for a further hour at 130° C. A further post-initiation is performed with 3.04 g of AMBN. The mixture is stirred for a further hour at 130° C. A further post-initiation is performed with 3.04 g of AMBN. The mixture is stirred for a further hour at 130° C. Product obtained: non-volatile fractions: 64.8%.

Stage 2:

50.0 g of stage 1 and 5.85 g xylene are weighed into a three-necked flask with stirrer, reflux condenser and gas inlet under a current of nitrogen and this is heated to 80° C. Next, 2.87 g of polyphosphoric acid is metered in within ca. 10 mins. The mixture is allowed to react for a further 4 hrs at 80° C. Product obtained: non-volatile fractions: 62.1%.

### Example B8

### Stage 1

138.92 g xylene and 24.4 g of 4-methyl-2,4-diphenyl-1-pentene are placed in a three-necked flask with stirrer, reflux condenser and gas inlet under a current of nitrogen and heated to 130° C. A mixture of 108.88 g of n-butyl acrylate, 65.24 g of butyl diglycol methacrylate, 42.6 g of hydroxyethyl methacrylate and 10.6 g of AMBN is metered in at this temperature at a feed rate of 0.6 mL/min (ca. 360 mins). The mixture is stirred for ca. 60 mins more at 130° C. After this, a post-initiation is performed with 3.12 g of AMBN. The mixture is stirred for a further hour at 130° C. A further post-initiation is performed with 3.12 g of AMBN. The mixture is stirred for a further hour at 130° C. A further post-initiation is performed with 3.12 g of AMBN. The mixture is stirred for a further hour at 130° C. Product obtained: non-volatile fractions: 66.1%.

Stage 2:

50.0 g of stage 1 and 7.00 g xylene are weighed into a three-necked flask with stirrer, reflux condenser and gas inlet under a current of nitrogen and this is heated to 80° C. Next, 2.88 g of polyphosphoric acid is metered in within ca. 10 mins. The mixture is allowed to react for a further 4 hrs at 80° C. Product obtained: non-volatile fractions: 63.0%.

### Example B9

### Stage 1

200 g of 1-methoxy-2-propyl acetate are placed in a three-necked flask with stirrer, reflux condenser and gas inlet under a current of nitrogen and heated to 130° C. A mixture of 130.24 g of methyl methacrylate 42.23 g of hydroxybutyl acrylate and 18.96 g of AMBN is metered in at this temperature at a feed rate of 0.6 mL/min. The mixture is stirred for ca. 60 mins more at 130° C. After this, a post-initiation is performed with 6 g of AMBN. The mixture is stirred for a further hour at 130° C. A further post-initiation is performed with 4 g of AMBN. The mixture is stirred for a further hour at 130° C. A further post-initiation is performed with 4 g of AMBN. The mixture is stirred for a further hour at 130° C. Product obtained: non-volatile fraction 49.9%.

Stage 2:

50.0 g of stage 1 and 4.55 g of 1-methoxy-2-propyl acetate are weighed into a three-necked flask with stirrer, reflux condenser and gas inlet under a current of nitrogen and this is heated to 80° C. Next, 3.17 g of polyphosphoric acid is metered in within ca. 10 mins. The mixture is allowed to react for a further 4 hrs at 80° C. Product obtained: non-volatile fractions: 49.2%.

### Example B10

### Stage 1

200.0 g of 1-methoxy-2-propyl acetate are placed in a three-necked flask with stirrer, reflux condenser and gas inlet under a current of nitrogen and heated to 130° C. A mixture of 130.24 g of methyl methacrylate 19.06 g of hydroxyethyl methacrylate, 21.11 g of hydroxybutyl acrylate and 18.96 g of AMBN is metered in at this temperature at a feed rate of 0.6 mL/min. The mixture is stirred for ca. 60 mins more at 130° C. After this, a post-initiation is performed with 6 g of AMBN. The mixture is stirred for a further hour at 130° C. A further post-initiation is performed with 4 g of AMBN. The mixture is stirred for a further hour at 130° C. A further post-initiation is performed with 4 g of AMBN. The mixture is stirred for a further hour at 130° C. Product obtained: Non-volatile fractions: 49.7%.

Stage 2:

50.0 g of stage 1 and 4.55 g of 1-methoxy-2-propyl acetate are weighed into a three-necked flask with stirrer, reflux condenser and gas inlet under a current of nitrogen and this is heated to 80° C. Next, 3.96 g of polyphosphoric acid is metered in within ca. 10 mins. The mixture is allowed to react for a further 4 hrs at 80° C. Product obtained: non-volatile fractions: 49.7%.

### Example B11

536 g of 1-methoxy-2-propyl acetate are placed in a three-necked flask with stirrer, reflux condenser and gas inlet under a current of nitrogen and heated to 130° C. 224.29 g of n-butyl acrylate, 54.08 g of hydroxybutyl acrylate, 78.80 g of ethylene glycol monomethacrylate monophosphate and 40.0 g of AMBN are simultaneously metered in at this temperature at a feed rate of 1.0 mL/min. The mixture is stirred for ca. 60 mins more at 130° C. After this, a post-initiation is performed with 6 g of AMBN. The mixture is stirred for a further hour at 130° C. A further post-initiation is performed with 6 g of AMBN. The mixture is stirred for a further hour at 130° C. A further post-initiation is performed with 4 g of AMBN. The mixture is stirred for a further hour at 130° C. Product obtained: Non-volatile fractions: 40.3%.

### Example B12

310 g of 1-methoxy-2-propyl acetate are placed in a three-necked flask with stirrer, reflux condenser and gas inlet under a current of nitrogen and heated to 130° C. 99.15 g of ethylhexyl methacrylate, 64.09 g of n-butyl acrylate, 22.77 g of hydroxyethyl methacrylate, 15.76 g of ethylene glycol monomethacrylate monophosphate, 2.70 g of vinylphosphonic acid and 20 g of tert-butyl 2-ethylperoxyhexanoate are simultaneously metered in at this temperature at a feed rate of 1.8 mL/min. The mixture is stirred for ca. 60 mins more at 130° C. After this, a post-initiation is performed with 6 g of tert-butyl 2-ethylperoxyhexanoate. The mixture is stirred for a further hour at 130° C. A further post-initiation is performed with 6 g of tert-butyl 2-ethylperoxyhexanoate. The mixture is stirred for a further hour at 130° C. Three more post-initiations are performed, each with 3 g of tert-butyl 2-ethylperoxyhexanoate. The mixture is stirred for a further hour at 130° C. Product obtained: non-volatile fractions: 39.6%.

### Example B13

255 g of 1-methoxy-2-propyl acetate are placed in a three-necked flask with stirrer, reflux condenser and gas inlet under a current of nitrogen and heated to 130° C. 115.35 g of n-butyl acrylate, 25.44 g of lauryl methacrylate, 8.61 g of methacrylic acid, 21.01 g of ethylene glycol monomethacrylate monophosphate and 20 g of AMBN are metered in simultaneously at this temperature at a feed rate of 1.5 mL/min. The mixture is stirred for ca. 60 mins more at 130° C. After this, a post-initiation is performed with 8 g of AMBN. The mixture is stirred for a further hour at 130° C. A further post-initiation is performed with 6 g of AMBN. The mixture is stirred for a further hour at 130° C. A further post-initiation is performed with 4 g of AMBN. The mixture is stirred for a further hour at 130° C. Product obtained: non-volatile fractions: 39.9%.

### Example B14

203.0 g of 1-methoxy-2-propyl acetate are placed in a three-necked flask with stirrer, reflux condenser and gas inlet under a current of nitrogen and heated to 130° C. 89.72 g of n-butyl acrylate, 42.66 g of n-butyl methacrylate, 18.02 g of acrylic acid, 15.76 g of ethylene glycol monomethacrylate monophosphate and 21 g of AMBN are simultaneously metered in at this temperature at a feed rate of 1.5 mL/min. The mixture is stirred for ca. 60 mins more at 130° C. After this, a post-initiation is performed with 8 g of AMBN. The mixture is stirred for a further hour at 130° C. A further post-initiation is performed with 6 g of AMBN. The mixture is stirred for a further hour at 130° C. A further post-initiation is performed with 4 g of AMBN. The mixture is stirred for a further hour at 130° C. Product obtained: non-volatile fractions: 45.2%.

### Example B15

260 g of 1-methoxy-2-propyl acetate are placed in a three-necked flask with stirrer, reflux condenser and gas inlet under a current of nitrogen and heated to 130° C. 128.17 g of n-butyl acrylate, 34.00 g of a hydroxyethyl acrylate-initiated polymer of ε-caprolactone (the product of ring-opening polymerization of c-caprolactone with hydroxyethyl acrylate as chain initiator: molecular weight=340 g/mol), 21.01 g of ethylene glycol monomethacrylate monophosphate and 20 g of AMBN are simultaneously metered in at this temperature at a feed rate of 1.5 mL/min. The mixture is stirred for ca. 60 mins more at 130° C. After this, a post-initiation is performed with 8 g of AMBN. The mixture is stirred for a further hour at 130° C. A further post-initiation is performed with 6 g of AMBN. The mixture is stirred for a further hour at 130° C. A further post-initiation is performed with 4 g of AMBN. The mixture is stirred for a further hour at 130° C. Product obtained: non-volatile fractions: 40.0%.

### Example B16

188 g of 1-methoxy-2-propyl acetate are placed in a three-necked flask with stirrer, reflux condenser and gas inlet under a current of nitrogen and heated to 130° C. 115.35 g of n-butyl acrylate, 56.86 g of a hydroxyethyl methacrylate-initiated polymer of ethylene oxide (the product of ring-opening polymerization of ethylene oxide with hydroxyethyl methacrylate as chain initiator: molecular weight=284 g/mol), 15.76 g of ethylene glycol monomethacrylate monophosphate and 20 g of AMBN are simultaneously metered in at this temperature at a feed rate of 1.5 mL/min. The mixture is stirred for ca. 60 mins more at 130° C. After this, a post-initiation is performed with 8 g of AMBN. The mixture is stirred for a further hour at 130° C. A further post-initiation is performed with 6 g of AMBN. The mixture is stirred for a further hour at 130° C. A further post-initiation is performed with 4 g of AMBN. The mixture is stirred for a further hour at 130° C. Product obtained: non-volatile fractions: 49.7%.

### 2. Use of the Copolymers as Adhesion Promoters

2.1 The solvents used below are commercially available: butyl acetate and butylglycol acetate (Brenntag), xylene in the form of an isomer mixture (Overlack), 1-methoxy-2-propyl acetate (as Dowanol PMA from Dow Chemicals) and Solvesso 100 (mixture of aromatic hydrocarbons from Exxon Mobil).

2.2 The raw materials used below are the following commercially available products:

Raw Materials for the Production of a Clear Lacquer
Setalux 1753 SS-70: Acrylate polyol, 70% in butyl acetate, from Nuplex Resins
Tinuvin 1130: Hydroxyphenylbenzotriazole, used as UV absorber from Ciba
Tinuvin 292: HALS, used as light stabilizer, from Ciba
BYK-331: Silicone-containing surface additive from Byk Chemie
BYK-358 N: Acrylate additive from Byk Chemie
TinStab BL 277: Dibutyltin dilaurate (DBTL) from Acros Chemicals, used as catalyst, 1% in butyl acetate
Tolonate HDT-90: Polyisocyanate from Perstorp, used as hardening agent

Raw Materials for the Production of a Base Lacquer
Setaqua 6760: Acrylate dispersion with a 38% solids content from Nuplex Resins as binder
DISPERBYK-180: Wetting and dispersion additive from Byk Chemie
Stapa IL Hydrolan 2154: Aluminum effect pigment from Eckart
BYK-028: Defoaming agent from Byk Chemie
BYK-347: Silicone surfactant as wetting agent from Byk Chemie
DMEA: Dimethylethanolamine from Merck, used as neutralizing agent (10% in H₂O)
AQUATIX-8421 Wax dispersion from Byk Chemie

Raw Materials for the Production of a Comparative Example
Lubrizol 2063: free acid of a complex carboxyl-phosphate ester from Lubrizol Corporation, 60%, commercially available adhesion promoter

2.3 General Operating Procedure for the Production of a Clear Lacquer

A mixture M1 containing Setalux 1753 SS-70 as polyol component and the further components mentioned in table 1 is produced by combining and stirring the individual components in the following order:

TABLE 1

| Mixture M1 | Quantity [g] |
|---|---|
| Setalux 1753 SS-70 | 476.0 |
| Butyl acetate | 60.0 |
| Xylene | 86.0 |
| 1-methoxy-2-propyl acetate | 120.0 |
| Solvesso 100 | 18.0 |
| Butylglycol acetate | 4.0 |
| Tinuvin 292 | 7.8 |
| Tinuvin 1130 | 2.7 |
| BYK-331 | 5.0 |
| BYK-358 N | 3.0 |
| TinStab BL 277 | 8.0 |

A copolymer of the examples B1, B3, B4, B5, B6, B7 or B8 or a comparison product V1 (Lubrizol 2063) respectively is added to this mixture M1. A total of 8 mixtures are thus obtained (M1B1, M1B3, M1B4, M1B5, M1B6, M1B7, M1B8 and M1V1). Here, the respective copolymer of V1 is in each case added to M1 in such a quantity that the resulting mixture M1B1, M1B3, M1B4, M1B5, M1B6, M1B7, M1B8 or M1V1 in each case contains 3 wt. %, based on the total weight of the resulting mixture, of the copolymer used according to the invention or of the comparison product V1. The mixture produced in each case is then homogenized over a period of 10 mins at a temperature in the range from 18-23° C. in a shaker (Skandex shaker) and then stored for a period of ca. 14 hours at a temperature in the range from 18-23° C.

A hardening agent solution according to table 2 and a diluent solution according to table 3 are incorporated directly before application (see section 2.5) into the respective mixture M1B1, M1B3, M1B4, M1B5, M1B6, M1B7, M1B8 and M1V1 by stirring with a spatula. The respective incorporation of the diluent solution is effected in order to achieve a setting of a 25-28″ spray viscosity with a DIN 4 CUP. Further, a hardening agent solution according to table 2 and a diluent solution according to table 3 are incorporated directly before application (see section 2.5) by stirring with a spatula into a mixture M1 into which neither a copolymer used according to the invention nor a comparison product V1 had been mixed (null sample).

TABLE 2

| Hardening agent solution | Quantity [g] |
|---|---|
| Tolonate HDT-90 | 188.0 |
| Butyl acetate | 19.0 |
| 1-methoxy-2-propyl acetate | 2.5 |

TABLE 3

| Diluent solution | Quantity [g] |
|---|---|
| Xylene | 500 |
| 1-methoxy-2-propyl acetate | 300 |
| Butyl acetate | 200 |

2.4 General Operating Procedure for the Production of an Aqueous Base Lacquer

A mixture M2 containing Stapa IL Hydrolan 2154 as effect pigment and the further components mentioned in table 4 is produced by combining and stirring the individual components.

TABLE 4

| Mixture M2 | Quantity [wt. %] |
|---|---|
| Deionized water | 28.4 |
| Butylglycol | 28.4 |
| DISPERBYK-180 | 1.2 |
| Stapa IL Hydrolan 2154 | 42.0 |

The mixture M2 has a solids content (content of aluminum effect pigment) of 25.2 wt. %, based on the total weight of M2.

The mixture M2 is incorporated into a mixture as a component for the production of an aqueous base lacquer M3 containing Setaqua 6760 as binder as well as the further components mentioned in table 5 by combining and stirring the individual components in the following order.

TABLE 5

| Aqueous base lacquer M3 | Quantity [wt. %] |
|---|---|
| Setaqua 6760 (38%) | 43.8 |
| BYK-028 | 0.5 |
| BYK-347 | 0.5 |
| Deionized water | 10.0 |
| DMEA | 0.16 |
| Mixture M2 | 13.0 |
| Deionized water | 10.0 |
| DMEA | 3.4 |
| AQUATIX 8421 | 5.5 |
| Deionized water | 13.1 |
| | 100.0 |

2.5 General Operating Procedure for Application of the Base Lacquer and the Clear Lacquer

E-coated metal plates from Krüppel (size 10 cm×20 cm) are pretreated by means of abrasive paper (from 3M, Scotch-Brite) and cleaned by washing with ethyl acetate. The base lacquer (mixture M3) is in each case applied onto a total of 9 E-coated plates by spray application with a HVLP (high volume low pressure) pistol and dried at a temperature in the range from 18 to 23° C. over a period of 30 minutes. The dry layer thickness of the base lacquer here is in each case in the range from 18 to 23 μm and is determined by use of a coating thickness gauge (Byko-Test 4500 from Byk-Gardner). Directly afterwards, the respective clear lacquer, which in each case is obtained, as described in section 2.3, by incorporation of a hardener solution according to table 2 and a diluent solution according to table 3 into each of the mixtures M1B1, M1B3, M1B4, M1B5, M1B6, M1B7, M1B8, M1V1 and M1 is applied by spray application with an HVLP pistol onto each one of the 9 E-coated plates coated with the base lacquer and dried over a period of 10 minutes at a temperature in the range from 18 to 23° C. and then in an oven over a period of 30 minutes at a temperature of 60° C. The dry layer thickness of the base lacquers here is in each case in the range from 35 to 40 μm and is determined by use of a coating thickness gauge (Byko-Test 4500 from Byk-Gardner).

2.6 Determination of the Adhesion Properties

The coated plates obtained as described in section 2.5 are stored over a period of 5 days at a temperature in the range from 18 to 23° C. and then in an oven over a period of 5 days at a temperature of 70° C. After removal from the oven, the plates are allowed to cool for 30 minutes. Next, a diagonal cross (arm length: 10 cm, angle 30°) is scratched into the coated plate down to the substrate, i.e. down to the E-coated plate, with a Sikkens scratching tool (model: Erichsen 463, 1 mm blade width). Directly afterwards, a steam jet test is performed. This is performed by means of a Walter LTA 1-H-A-L-P Steam Jet Tester at a water temperature of 60° C., an angle of 30°, and a water pressure of 60 bar over a period of 1 minute and a distance of 10 cm from the coated substrate. During this, such a steam jet is directed from the appropriate distance and angle onto the scratch region of the coated substrate.

In all cases, an adhesion break, i.e. a delamination between base lacquer layer and clear lacquer layer was observed. Detachment of the base lacquer layer from the E-coated plate was in no case observed.

The adhesive properties are assessed by measuring with a ruler the width in [mm] of a delamination caused by the steam jet treatment along the scratch. The results are summarized in table 6.

TABLE 6

| | Width of the delamination in the |
|---|---|
| Clear lacquer layer of the coated | scratch region after steam jet |
| E-coated plate based on | treatment [mm] |
| M1 (Null sample) | 5 mm |
| M1B4 | 2 mm |
| M1B1 | 4 mm |
| M1B3 | 4 mm |
| M1B5 | 3 mm |
| M1B6 | 3 mm |
| M1B7 | 3 mm |
| M1B8 | 3 mm |
| M1V1 | 5 mm |

As can be seen from table 6, with use of the copolymer used according to the invention as an adhesion-strengthening additive in M1B1 and M1B3 to M1B8, a reduction in the width of the delamination by at least 20% compared to M1V1 containing a conventional adhesion promoter can be achieved.

1. A method comprising utilizing as an adhesion-strengthening additive, at least one homopolymer or copolymer obtained by polymerization of ethylenically unsaturated monomers,
which is composed of at least one structural unit (W0) and optionally at least one further structural unit (W3) different from (W0),
wherein
each structural unit (W0) both contains at least one functional group which contains at least one phosphorus atom, and also contains at least one functional group reactive towards an isocyanate group,
and the homopolymer or copolymer, based on the total quantity of the at least one structural unit (W0) and optionally (W3) within the polymer main chain of the homopolymer or copolymer, contains the following proportions in mol. %:
1 to 100 mol. % of the structural units (W0) and
0 to 99 mol. % of the structural units (W3),
or which is composed of at least two structural units (W1) and (W2) different from one another and optionally at least one further structural unit (W3) different from (W1) and (W2),
wherein
each structural unit (W1) contains at least one functional group which contains at least one phosphorus atom, and optionally at least one part of the structural units (W1) additionally contains at least one functional group reactive towards an isocyanate group, and
each structural unit (W2) contains at least one functional group reactive towards an isocyanate group, wherein none of the structural units (W2) contains phosphorus atoms,
and the homopolymer or copolymer, based on the total quantity of the at least two structural units (W1) and (W2) and optionally (W3) within the polymer main chain of the homopolymer or copolymer, contains the following proportions in mol. %:
1 to 80 mol. % of the structural units (W1),
1 to 80 mol. % of the structural units (W2) and
0 to 98 mol. % of the structural units (W3),
wherein the adhesion-strengthening additive is provided as a component of a coating composition, as a component of an adhesion-promoting layer, or as a component of a primer.

2. The method as claimed in claim 1, characterized in that
70 to 100 mol. % of the at least one functional group of each of the structural units (W1) or (W0) of the homopolymer or copolymer containing at least one phosphorus atom are each mutually independently selected from the group consisting of phosphonic acid groups, at least partially esterified phosphonic acid groups, at least partially esterified phosphoric acid groups and respective corresponding salts of these groups,
and/or
70 to 100 mol. % of the at least one functional group reactive towards an isocyanate group of each of the structural units (W2) or (W0) and optionally (W1) of the homopolymer or copolymer are each mutually independently selected from the group consisting of optionally protected hydroxyl groups, thiol groups, epoxide groups, carboxyl groups, optionally protected primary amino groups and optionally protected secondary amino groups.

3. The method as claimed in claim 1, characterized in that the structural unit (W3) different from (W0) or from (W1) and (W2) is derived from an ethylenically unsaturated monomer, which, when it is used as a monomer for the production of a homopolymer obtained therefrom, forms a homopolymer which has a glass transition temperature (T_{g}) of less than 50° C.

4. The method as claimed in claim 1, characterized in that the homopolymer or copolymer is obtained
by radical polymerization of
(a) at least one ethylenically unsaturated monomer capable of forming the structural unit (W1), which contains at least one functional group which contains at least one phosphorus atom, at least one ethylenically unsaturated monomer capable of forming the structural unit (W2), which contains at least one functional group reactive towards an isocyanate group, and optionally at least one ethylenically unsaturated monomer capable of forming the structural unit (W3),
or by radical polymerization of
(b1) at least two ethylenically unsaturated monomers different from each other capable of forming the structural unit (W2), which each mutually independently contain at least one functional group reactive towards an isocyanate group, and optionally at least one ethylenically unsaturated monomer capable of forming the structural unit (W3),
or
of at least one ethylenically unsaturated monomer capable of forming the structural unit (W2), which contains at least one functional group reactive towards an isocyanate group, and at least one ethylenically unsaturated monomer capable of forming the structural unit (W3),
and
(b2) partial conversion of the functional groups reactive towards isocyanate groups contained in the structural units (W2) of the homopolymer or copolymer obtained according to step (b1) into functional groups which contain at least one phosphorus atom, for the formation of structural units (W1) or (W0) within the homopolymer or copolymer
or by radical polymerization of
(c) at least one ethylenically unsaturated monomer capable of forming the structural unit (W0), which both contains at least one functional group which contains at least one phosphorus atom, and also contains at least one functional group reactive towards an isocyanate group, and optionally at least one ethylenically unsaturated monomer capable of forming the structural unit (W3).

5. The method as claimed in claim 1, characterized in that the homopolymer or copolymer is obtained by radical polymerization of
(b1a) at least two ethylenically unsaturated monomers different from each other capable of forming the structural unit (W2), which each contain at least one optionally protected hydroxyl group reactive towards an isocyanate group, and optionally at least one ethylenically unsaturated monomer capable of forming the structural unit (W3), or of
at least one ethylenically unsaturated monomer capable of forming the structural unit (W2), which contains at least one optionally protected hydroxyl group reactive towards an isocyanate group, and at least one ethylenically unsaturated monomer capable of forming the structural unit (W3),
and
(b2a) partial phosphorylation of the hydroxyl groups contained in the structural units (W2) of the homopolymer or copolymer obtained according to step (b1a) for the formation of structural units (W1) or (W0) within the homopolymer or copolymer.

6. The method as claimed in claim 1, characterized in that the homopolymer or copolymer is obtained by radical polymerization of
at least one ethylenically unsaturated monomer selected from the group consisting of vinylphosphonic acid, vinylphosphonic acid in a form at least partially esterified with a C₁₋₈ alkyl alcohol, vinylphosphoric acid in a form at least partially esterified with a C₁₋₈ alkyl alcohol, alkyl (meth)acrylates, cycloalkyl (meth)acrylates, aryl (meth)acrylates and alkylaryl (meth)acrylates, wherein the alkyl residues, cycloalkyl residues, aryl residues or alkylaryl residues of these (meth)acrylates each contain at least one functional group containing at least one phosphorus atom, for the formation of structural units (W1) within the copolymer,
and
at least one ethylenically unsaturated monomer selected from the group consisting of alkyl (meth)acrylates, cycloalkyl (meth)acrylates, aryl (meth)acrylates and alkylaryl (meth)acrylates, wherein the alkyl residues, cycloalkyl residues, aryl residues or alkylaryl residues of these (meth)acrylates each contain at least one OH group or at least one protected OH group, alkyl(meth)acrylamides, cycloalkyl(meth)acrylamides, aryl(meth)acrylamides and alkylaryl(meth)acrylamides, wherein the alkyl residues, cycloalkyl residues, aryl residues or alkylaryl residues of these (meth)acrylamides each contain at least one OH group or at least one protected OH group, allyl alcohol, vinyl alcohol and hydroxyalkyl vinyl ethers, for the formation of structural units (W2) within the copolymer,
and optionally at least one ethylenically unsaturated monomer selected from the group consisting of alkyl (meth)acrylates, cycloalkyl (meth)acrylates, aryl (meth)acrylates, heteroaryl (meth)acrylates and alkylaryl (meth)acrylates, wherein the alkyl residues, cycloalkyl residues, aryl residues, heteroaryl residues or alkylaryl residues of these (meth)acrylates can optionally each contain at least one tertiary amino group and/or at least one alkoxy group, for the formation of structural units (W3) within the copolymer,
or
by radical polymerization of at least one ethylenically unsaturated monomer selected from the group consisting of alkyl (meth)acrylates, cycloalkyl (meth)acrylates, aryl (meth)acrylates and alkylaryl (meth)acrylates, wherein the alkyl residues, cycloalkyl residues, aryl residues or alkylaryl residues of these (meth)acrylates each contain at least one OH group or at least one protected OH group, alkyl(meth)acrylamides, cycloalkyl(meth)acrylamides, aryl(meth)acrylamides and alkylaryl(meth)acrylamides, wherein the alkyl residues, cycloalkyl residues, aryl residues or alkylaryl residues of these (meth)acrylamides each contain at least one OH group or at least one protected OH group, allyl alcohol, vinyl alcohol and hydroxyalkyl vinyl ethers, for the formation of structural units (W2) within the copolymer,
and at least one ethylenically unsaturated monomer selected from the group consisting of alkyl (meth)acrylates, cycloalkyl (meth)acrylates, aryl (meth)acrylates, heteroaryl (meth)acrylates and alkylaryl (meth)acrylates, wherein the alkyl residues, cycloalkyl residues, aryl residues, heteroaryl residues or alkylaryl residues of these (meth)acrylates can optionally each contain at least one tertiary amino group and/or at least one alkoxy group, for the formation of structural units (W3) within the copolymer,
and partial phosphorylation of the hydroxyl groups contained in the structural units (W2) of the copolymer obtained after radical polymerization for the formation of structural units (W1) or (W0) within the copolymer,
or by radical polymerization of at least one ethylenically unsaturated monomer selected from the group consisting of alkyl (meth)acrylates, cycloalkyl (meth)acrylates, aryl (meth)acrylates and alkylaryl (meth)acrylates, wherein the alkyl residues, cycloalkyl residues, aryl residues or alkylaryl residues of these (meth)acrylates each contain both at least one functional group containing at least one phosphorus atom and also at least one OH group or at least one protected OH group, for the formation of structural units (W0) within the homopolymer or copolymer,
and optionally at least one ethylenically unsaturated monomer selected from the group consisting of alkyl (meth)acrylates, cycloalkyl (meth)acrylates, aryl (meth)acrylates, heteroaryl (meth)acrylates and alkylaryl (meth)acrylates, wherein the alkyl residues, cycloalkyl residues, aryl residues, heteroaryl residues or alkylaryl residues of these (meth)acrylates can optionally each contain at least one tertiary amino group and/or at least one alkoxy group, for the formation of structural units (W3) within the homopolymer or copolymer.

7. The method as claimed in claim 1, characterized in that the homopolymer or copolymer is obtained by radical polymerization of
at least one ethylenically unsaturated monomer selected from the group consisting of vinylphosphonic acid, vinylphosphonic acid in a form at least partially esterified with a C₁₋₈ alkyl alcohol, vinylphosphoric acid in a form at least partially esterified with a C₁₋₈ alkyl alcohol, 2-(meth)acryloyloxyethyl phosphate, 3-(meth)acryloyloxypropyl phosphate, 4-(meth)acryloyloxybutyl phosphate, 10-methacryloyloxydecyl dihydrogen phosphate, ethyl-2-[4-(dihydroxyphosphoryl)-2-oxabutyl]acrylate and 2,4,6-trimethylphenyl-2-[4-(dihydroxyphosphoryl)-2-oxabutyl]acrylate, for the formation of structural units (W1) within the copolymer,
and
at least one ethylenically unsaturated monomer selected from the group consisting of hydroxyethyl (meth)acrylate, hydroxypropyl (meth)acrylate and hydroxybutyl (meth)acrylate for the formation of structural units (W2) within the copolymer,
and optionally at least one ethylenically unsaturated monomer selected from the group consisting of methyl (meth)acrylate, ethyl (meth)acrylate, n-butyl (meth)acrylate, i-butyl (meth)acrylate, t-butyl (meth)acrylate, lauryl (meth)acrylate, 2-ethylhexyl (meth)acrylate, stearyl (meth)acrylate, allyl (meth)acrylate, tridecyl (meth)acrylate, and benzyl (meth)acrylate, for the formation of structural units (W3) within the copolymer,
or
by radical polymerization of at least one ethylenically unsaturated monomer selected from the group consisting of hydroxyethyl (meth)acrylate, glycidyl (meth)acrylate, hydroxypropyl (meth)acrylate and hydroxybutyl (meth)acrylate for the formation of structural units (W2) within the copolymer,
and at least one ethylenically unsaturated monomer selected from the group consisting of methyl (meth)acrylate, ethyl (meth)acrylate, n-butyl (meth)acrylate, i-butyl (meth)acrylate, t-butyl (meth)acrylate, lauryl (meth)acrylate, 2-ethylhexyl (meth)acrylate, stearyl (meth)acrylate, allyl (meth)acrylate, tridecyl (meth)acrylate, and benzyl (meth)acrylate, for the formation of structural units (W3) within the copolymer,
and partial phosphorylation of the optionally protected hydroxyl groups contained in the structural units (W2) of the copolymer obtained after radical copolymerization for the formation of structural units (W1) or (W0) within the copolymer
or
by radical polymerization of at least one ethylenically unsaturated monomer selected from the group consisting of [(3-(meth)acryloyloxy-2-hydroxypropyl)]phosphate and [(2-(meth)acryloyloxy-3-hydroxypropyl)]phosphate for the formation of structural units (W0) within the homopolymer or copolymer,
and optionally at least one ethylenically unsaturated monomer selected from the group consisting of methyl (meth)acrylate, ethyl (meth)acrylate, n-butyl (meth)acrylate, i-butyl (meth)acrylate, t-butyl (meth)acrylate, lauryl (meth)acrylate, 2-ethylhexyl (meth)acrylate, stearyl (meth)acrylate, allyl (meth)acrylate, tridecyl (meth)acrylate, and benzyl (meth)acrylate, for the formation of structural units (W3) within the homopolymer or copolymer.

8. The method as claimed in claim 1, characterized in that the copolymer is obtained by radical polymerization of
at least one ethylenically unsaturated monomer selected from the group consisting of hydroxyethyl (meth)acrylate, glycidyl (meth)acrylate, hydroxypropyl (meth)acrylate and hydroxybutyl (meth)acrylate for the formation of structural units (W2) within the copolymer
and
at least one ethylenically unsaturated monomer selected from the group consisting of methyl (meth)acrylate, ethyl (meth)acrylate, n-butyl (meth)acrylate and 2-ethylhexyl (meth)acrylate for the formation of structural units (W3) within the copolymer,
and partial phosphorylation of the optionally protected hydroxyl groups contained in the structural units (W2) of the copolymer obtained after radical copolymerization for the formation of structural units (W1) or (W0) within the copolymer,
or by radical polymerization of
at least one ethylenically unsaturated monomer selected from the group consisting of 2-(meth)acryloyloxyethyl phosphate, 3-(meth)acryloyloxypropyl phosphate and 4-(meth)acryloyloxybutyl phosphate, for the formation of structural units (W1) within the copolymer,
and
at least one ethylenically unsaturated monomer selected from the group consisting of hydroxyethyl (meth)acrylate, hydroxypropyl (meth)acrylate and hydroxybutyl (meth)acrylate for the formation of structural units (W2) within the copolymer,
and
at least one ethylenically unsaturated monomer selected from the group consisting of methyl (meth)acrylate, ethyl (meth)acrylate, n-butyl (meth)acrylate and 2-ethylhexyl (meth)acrylate for the formation of structural units (W3) within the copolymer or by radical copolymerization of [(2-(meth)acryloyloxy-3-hydroxypropyl)]phosphate for the formation of structural units (W0) within the copolymer
and
at least one ethylenically unsaturated monomer selected from the group consisting of methyl (meth)acrylate, ethyl (meth)acrylate, n-butyl (meth)acrylate and 2-ethylhexyl (meth)acrylate for the formation of structural units (W3) within the copolymer.

9. The method as claimed in claim 1, characterized in that
the copolymer, based on the total quantity of the at least two structural units (W1) and (W2) and (W3) within the polymer main chain of the copolymer, contains the following proportions in mol. %:
3 to 40 mol. % of the structural units (W1),
3 to 40 mol. % of the structural units (W2) and
20 to 94 mol. % of the structural units (W3),
or that the copolymer, based on the total quantity of the at least one structural unit (W0) and (W3) within the polymer main chain of the copolymer, contains the following proportions in mol. %:
6 to 80 mol. % of the structural units (W0) and
20 to 94 mol. % of the structural units (W3).

10. The method as claimed in claim 1, characterized in that the homopolymer or copolymer is used as an adhesion-strengthening additive for adhesion promotion between a substrate optionally coated with at least one layer and at least one layer to be applied onto the substrate optionally coated with at least one layer.

11. The method as claimed in claim 1, characterized in that the homopolymer or copolymer is used as an adhesion-strengthening additive as a component of a coating composition for application of a layer onto a substrate coated with at least one layer.

12. A coating composition comprising
(A) at least one homopolymer or copolymer obtained by polymerization of ethylenically unsaturated monomers,
which is composed of at least one structural unit (W0) and optionally at least one further structural unit (W3) different from (W0),
wherein
each structural unit (W0) both contains at least one functional group which contains at least one phosphorus atom, and also contains at least one functional group reactive towards an isocyanate group,
and the homopolymer or copolymer, based on the total quantity of the at least one structural unit (W0) and optionally (W3) within the polymer main chain of the homopolymer or copolymer, contains the following proportions in mol. %:
1 to 100 mol. % of the structural units (W0) and
0 to 99 mol. % of the structural units (W3),
or which is composed of at least two structural units (W1) and (W2) different from one another and optionally at least one further structural unit (W3) different from (W1) and (W2),
wherein
each structural unit (W1) contains at least one functional group which contains at least one phosphorus atom, and optionally at least one part of the structural units (W1) additionally contains at least one functional group reactive towards an isocyanate group, and
each structural unit (W2) contains at least one functional group reactive towards an isocyanate group, wherein none of the structural units (W2) contains phosphorus atoms,
and the homopolymer or copolymer, based on the total quantity of the at least two structural units (W1) and (W2) and optionally (W3) within the polymer main chain of the homopolymer or copolymer, contains the following proportions in mol. %:
1 to 80 mol. % of the structural units (W1),
1 to 80 mol. % of the structural units (W2) and
0 to 98 mol. % of the structural units (W3),
for use as an adhesion-strengthening additive in a quantity in a range from 0.1 to 15 wt. %, based on the total weight of the coating composition, and
(B) at least one binder in a quantity in a range from 20 to 99 wt. %, based on the total weight of the coating composition.

13. The coating composition as claimed in claim 12, characterized in that 70 to 100 wt. % of the binder (B) contained in the coating composition are selected from the group consisting of polyurethanes, polyesters, polyamides, polyureas, polyvinyl chlorides, polystyrenes, polycarbonates, poly(meth)acrylates, epoxy resins and mixtures thereof.

14. A method comprising utilizing the coating composition as claimed in claim 12 as clear lacquer, production line lacquer, repair lacquer or maintenance lacquer.

15. A substrate at least partially coated with the coating composition as claimed in claim 12.

16. The substrate as claimed in claim 15, characterized in that 70 to 100 wt. % of the binder (B) contained in the coating composition are selected from the group consisting of polyurethanes, polyesters, polyamides, polyureas, polyvinyl chlorides, polystyrenes, polycarbonates, poly(meth)acrylates, epoxy resins and mixtures thereof.

17. The coating composition as claimed in claim 12, characterized in that
70 to 100 mol. % of the at least one functional group of each of the structural units (W1) or (W0) of the homopolymer or copolymer containing at least one phosphorus atom are each mutually independently selected from the group consisting of phosphonic acid groups, at least partially esterified phosphonic acid groups, at least partially esterified phosphoric acid groups and respective corresponding salts of these groups,
and/or
70 to 100 mol. % of the at least one functional group reactive towards an isocyanate group of each of the structural units (W2) or (W0) and optionally (W1) of the homopolymer or copolymer are each mutually independently selected from the group consisting of optionally protected hydroxyl groups, thiol groups, epoxide groups, carboxyl groups, optionally protected primary amino groups and optionally protected secondary amino groups.

18. The coating composition as claimed in claim 12, characterized in that the structural unit (W3) different from (W0) or from (W1) and (W2) is derived from an ethylenically unsaturated monomer, which, when it is used as a monomer for the production of a homopolymer obtained therefrom, forms a homopolymer which has a glass transition temperature (T_{g}) of less than 50° C.

19. The coating composition as claimed in claim 12, characterized in that
the copolymer, based on the total quantity of the at least two structural units (W1) and (W2) and (W3) within the polymer main chain of the copolymer, contains the following proportions in mol. %:
3 to 40 mol. % of the structural units (W1),
3 to 40 mol. % of the structural units (W2) and
20 to 94 mol. % of the structural units (W3),
or that the copolymer, based on the total quantity of the at least one structural unit (W0) and (W3) within the polymer main chain of the copolymer, contains the following proportions in mol. %:
6 to 80 mol. % of the structural units (W0) and
20 to 94 mol. % of the structural units (W3).
